(19) United States
(12) Patent Application Publication
(10) Pub. No.: US 2026/0136038 A1
(43) Pub. Date: May 14, 2026

(54) WARP DELTA MODE SIGNALING

(71) Applicant: GOOGLE LLC, Mountain View, CA (US)

(72) Inventors: Mohammed Golam Sarwer, San Jose, CA (US); Debargha Mukherjee, Cupertino, CA (US); Jianle Chen, San Diego, CA (US)

(21) Appl. No.: 19/384,101

(22) Filed: Nov. 10, 2025

Related U.S. Application Data
(60) Provisional application No. 63/719,999, filed on Nov. 13, 2024.

(51) Int. Cl. H04N 19/52; H04N 19/105; H04N 19/124; H04N 19/139; H04N 19/159; H04N 19/176

(52) U.S. Cl. CPC H04N 19/52; H04N 19/105; H04N 19/124; H04N 19/139; H04N 19/159; H04N 19/176

(57) ABSTRACT

Obtaining reconstructed block data for a current block of a current frame includes obtaining a warp reference list for the current block, accessing, from an encoded bitstream, a warp reference list index value corresponding to predicted warp motion model parameters from the warp reference list, obtaining current warp motion model parameters by combining the predicted warp motion model parameters and differential warp motion model parameters determined from the encoded bitstream, obtaining a motion vector prediction using the current warp motion model parameters, obtaining predicted block data for the current block using the motion vector prediction, obtaining decoded block data by decoding encoded block data accessed from the encoded bitstream, and including, in the reconstructed block data, a sum of the decoded block data and the predicted block data, including the reconstructed block data in reconstructed frame data for the current frame, and outputting the reconstructed frame data.

### CROSS-REFERENCE TO RELATED APPLICATION(S)

This application claims priority to and the benefit of U.S. Provisional Application Patent Ser. No. 63/719,999, filed Nov. 13, 2025, the entire disclosure of which is hereby incorporated by reference.

### BACKGROUND

Digital images and video can be used, for example, on the internet, for remote business meetings via video conferencing, high-definition video entertainment, video advertisements, or sharing of user-generated content. Due to the large amount of data involved in transferring and processing image and video data, high-performance compression may be advantageous for transmission and storage. Accordingly, it would be advantageous to provide high-resolution image and video transmitted over communications channels having limited bandwidth.

### SUMMARY

This application relates to encoding and decoding of image data, video stream data, or both for transmission, storage, or both. Disclosed herein are aspects of systems, methods, and apparatuses for encoding and decoding using warped motion compensation.

Variations in these and other aspects will be described in additional detail hereafter.

An aspect is a method for decoding using warped motion compensation. The method includes obtaining reconstructed block data for a current block of a current frame of a sequence of frames, including the reconstructed block data in reconstructed frame data for the current frame, and outputting the reconstructed frame data. Obtaining the reconstructed block data may include obtaining a warp reference list for the current block, accessing, from an encoded bitstream, a warp reference list index value corresponding to predicted warp motion model parameters from the warp reference list, obtaining current warp motion model parameters by combining the predicted warp motion model parameters and differential warp motion model parameters determined from the encoded bitstream, obtaining a motion vector prediction using the current warp motion model parameters, obtaining predicted block data for the current block using the motion vector prediction, obtaining decoded block data by decoding encoded block data accessed from the encoded bitstream, and including, in the reconstructed block data, a sum of the decoded block data and the predicted block data.

An aspect is non-transitory computer-readable storage medium storing an encoded bitstream for decoding by a processor, the encoded bitstream comprising a warp reference list index value corresponding to predicted warp motion model parameters from a warp reference list, a differential warp motion model parameters quantization step size mode indicator indicating a differential warp motion model parameters quantization step size mode for obtaining a differential warp motion model parameters quantization step size, a differential warp motion model parameter index value, and encoded block data for a current block of a current frame of a sequence of frames, the encoded block data representing the current block in accordance with a warped motion prediction mode corresponding to current warp motion model parameters obtained in accordance with the predicted warp motion model parameters and differential warp motion model parameters obtained in accordance with the differential warp motion model parameter index value and the differential warp motion model parameters quantization step size.

An aspect is an apparatus for decoding using warped motion compensation. The apparatus comprising a non-transitory computer-readable medium and a processor configured to execute instructions stored on the non-transitory computer-readable medium to perform decoding using warped motion compensation. To perform decoding using warped motion compensation, the processor may execute the instructions to obtain reconstructed block data for a current block of a current frame of a sequence of frames, include the reconstructed block data in reconstructed frame data for the current frame, and output the reconstructed frame data. To obtain the reconstructed block data the processor may execute the instructions to obtain a warp reference list for the current block, access, from an encoded bitstream, a warp reference list index value corresponding to predicted warp motion model parameters from the warp reference list, obtain current warp motion model parameters, wherein, to obtain the current warp motion model parameters, the processor executes the instructions to combine the predicted warp motion model parameters and differential warp motion model parameters determined from the encoded bitstream, obtain a motion vector prediction, wherein, to obtain the motion vector prediction, the processor executes the instructions to use the current warp motion model parameters to obtain the motion vector prediction, obtain predicted block data for the current block, wherein, to obtain the predicted block data, the processor executes the instructions to use the motion vector prediction to obtain the predicted block data, obtain decoded block data, wherein, to obtain the decoded block data, the processor executes the instructions to decode encoded block data accessed from the encoded bitstream, and include, in the reconstructed block data, a sum of the decoded block data and the predicted block data;

These and other aspects of the present disclosure are disclosed in the following detailed description of the embodiments, the appended claims, and the accompanying figures.

### BRIEF DESCRIPTION OF THE DRAWINGS

The description herein makes reference to the accompanying drawings wherein like reference numerals refer to like parts throughout the several views unless otherwise noted or otherwise clear from context.

FIG. 1 is a diagram of a computing device in accordance with implementations of this disclosure.

FIG. 2 is a diagram of a computing and communications system in accordance with implementations of this disclosure.

FIG. 3 is a diagram of a video stream for use in encoding and decoding in accordance with implementations of this disclosure.

FIG. 4 is a block diagram of an encoder in accordance with implementations of this disclosure.

FIG. 5 is a block diagram of a decoder in accordance with implementations of this disclosure.

FIG. 6 is a block diagram of a representation of a portion of a frame in accordance with implementations of this disclosure.

FIG. 7 is a flowchart diagram of an example of encoding using warped motion compensation in accordance with implementations of this disclosure.

FIG. 8 is a flowchart diagram of an example of obtaining a warp reference list in accordance with implementations of this disclosure.

FIG. 9 is a flowchart diagram of an example of obtaining derived warp motion model parameters based on one or more corner context blocks in accordance with implementations of this disclosure.

FIG. 10 is a block diagram of an example of corner context blocks in accordance with implementations of this disclosure.

FIG. 11 is a block diagram of an example of reference frame location differences in accordance with implementations of this disclosure.

FIG. 12 is a flowchart diagram of an example of obtaining warp motion model parameters based on one or more context blocks in accordance with implementations of this disclosure.

FIG. 13 is a block diagram of an example of a defined sequence, such as for obtaining warp motion model parameters based on one or more context blocks, in accordance with implementations of this disclosure.

FIG. 14 is a flowchart diagram of an example of obtaining warp motion model parameters based on a warp motion parameter bank in accordance with implementations of this disclosure.

FIG. 15 is a flowchart diagram of an example of obtaining warp motion model parameters based on global warp motion model parameters associated with the current reference frame in accordance with implementations of this disclosure.

FIG. 16 is a flowchart diagram of an example of obtaining warp motion model parameters based on defined warp motion model parameters in accordance with implementations of this disclosure.

FIG. 17 is a flowchart diagram of an example of decoding using warped motion compensation in accordance with implementations of this disclosure.

FIG. 18 is a flowchart diagram of an example of obtaining warp motion model parameters based on a number of signaled warp motion model parameters.

FIG. 19 is a flowchart diagram of an example of decoding using warped motion compensation based on a number of signaled warp motion model parameters.

FIG. 20 is a block diagram of an example of a defined sequence, such as for determining whether to allow a current block to use six-parameter signaling.

### DETAILED DESCRIPTION

Image and video compression schemes may include breaking an image, or frame, into smaller portions, such as blocks, and generating an output bitstream using techniques to minimize the bandwidth utilization of the information included for each block in the output. In some implementations, the information included for each block in the output may be limited by reducing spatial redundancy, reducing temporal redundancy, or a combination thereof. For example, temporal or spatial redundancies may be reduced by predicting a frame, or a portion thereof, based on information available to both the encoder and decoder, and including information representing a difference, or residual, between the predicted frame and the original frame in the encoded bitstream. The residual information may be further compressed by transforming the residual information into transform coefficients (e.g., energy compaction), quantizing the transform coefficients, and entropy coding the quantized transform coefficients. Other coding information, such as motion information, may be included in the encoded bitstream, which may include transmitting differential information based on predictions of the encoding information, which may be entropy coded to further reduce the corresponding bandwidth utilization. An encoded bitstream can be decoded to reconstruct the blocks and the source images from the limited information. In some implementations, the accuracy, efficiency, or both, of coding a block using either inter-prediction or intra-prediction may be limited.

Block-based hybrid video coding techniques, or codecs, to improve coding efficiency, predict a block of a frame either from one or more previously decoded, or reconstructed, frames (inter prediction) or from the current frame (intra prediction). In inter prediction, a motion compensated prediction is obtained where a motion vector (MV) of a respective predicted block is generated. To decode an inter-predicted block, a decoder obtains, such as generates, a dynamic reference list (DRL), which is a list of reference motion vectors, and which is generated from the previously decoded neighboring blocks in the current frame and collocated blocks of the reference frame. The dynamic reference list includes a list of reference motion vectors of a prediction block.

To improve the signaling of the motion vector, directly signaling the motion vector is omitted and a difference between the reference motion vector and the motion vector used to obtain the predicted block is signaled (differential motion vector). To indicate the candidate reference motion vector from the dynamic reference list to use as the reference motion vector, an index value in the dynamic reference list corresponding to the candidate reference motion vector is signaled. In some inter prediction modes, the reference motion vector is used as the motion vector for coding the current block. In some inter prediction modes, the differential motion vector is signaled and a combination, or summation, of the differential motion vector and the reference motion vector is used as the motion vector for coding the current block.

Some block-based hybrid video coding techniques, or codecs, may be limited to reducing temporal redundancy using a translational motion model, which may inefficiently or inaccurately represent non-translational motion. Some block-based hybrid video coding techniques, or codecs, may include warped motion video coding, including warped motion compensation, which may improve the efficiency, accuracy, or both, relative to block-based hybrid video coding techniques that are limited to reducing temporal redundancy using a translational motion model, with respect to non-translational motion. For example, some block-based hybrid video coding techniques may include warped motion video coding using a global warp motion model, a local warp motion model, or both.

Some block-based hybrid video coding techniques, or codecs, that include warped motion video coding may signal warp motion model parameters inefficiently. For example, some block-based hybrid video coding techniques, or codecs, that include warped motion video coding may signal warp motion model parameters, such as global affine motion parameters, on a per-frame or a per-group-of-frames basis. Some block-based hybrid video coding techniques, or codecs, that include warped motion video coding may omit signaling warp motion model parameters, such as warp motion model parameters for a local warp motion model. Some block-based hybrid video coding techniques, or codecs, that include warped motion video coding obtain a warp reference list, which is like the dynamic reference list described herein except as is described herein or as is otherwise clear from context and decode inter-predicted blocks using warp model parameters obtained from the warp reference list. In some block-based hybrid video coding techniques, or codecs, that include warped motion video coding the warp reference list is obtained from neighboring context blocks, a warp parameter bank, a global motion model, and/or defined warp model parameters.

The encoding and decoding using warped motion compensation described herein improves on video coding techniques, or codecs, by populating the warp reference list using candidate warp motion parameters derived from corner context motion vectors. The encoding and decoding using warped motion compensation described herein improves on video coding techniques, or codecs, by signaling a motion vector difference for warp motion vectors for some motion modes. The warped delta mode signaling described herein is a flexible signaling of the parameters that allows tradeoffs between the number of parameters and the accuracy of the resulting warp model and hence the accuracy of the predictors used for warped motion compensation. Details of these improvements are described below after an environment in which the improvements may be used.

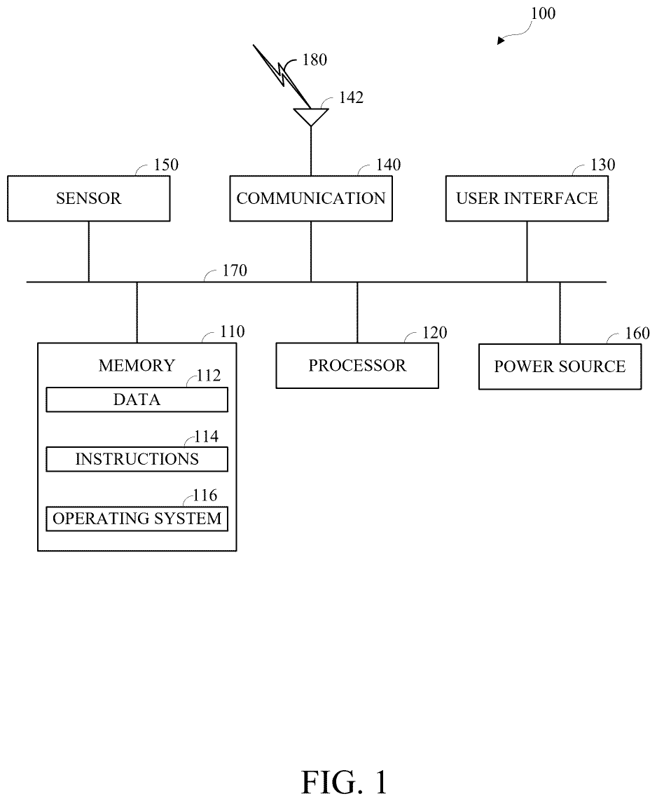

FIG. 1 is a diagram of a computing device 100 in accordance with implementations of this disclosure. The computing device 100 shown includes a memory 110, a processor 120, a user interface (UI) 130, an electronic communication unit 140, a sensor 150, a power source 160, and a bus 170. As used herein, the term “computing device” includes any unit, or a combination of units, capable of performing any method, or any portion or portions thereof, disclosed herein.

The computing device 100 may be a stationary computing device, such as a personal computer (PC), a server, a workstation, a minicomputer, or a mainframe computer; or a mobile computing device, such as a mobile telephone, a personal digital assistant (PDA), a laptop, or a tablet PC. Although shown as a single unit, any one element or elements of the computing device 100 can be integrated into any number of separate physical units. For example, the user interface 130 and processor 120 can be integrated in a first physical unit and the memory 110 can be integrated in a second physical unit.

The memory 110 can include any non-transitory computer-usable or computer-readable medium, such as any tangible device that can, for example, contain, store, communicate, or transport data 112, instructions 114, an operating system 116, or any information associated therewith, for use by or in connection with other components of the computing device 100. The non-transitory computer-usable or computer-readable medium can be, for example, a solid-state drive, a memory card, removable media, a read-only memory (ROM), a random-access memory (RAM), any type of disk including a hard disk, a floppy disk, an optical disk, a magnetic or optical card, an application-specific integrated circuits (ASICs), or any type of non-transitory media suitable for storing electronic information, or any combination thereof.

Although shown a single unit, the memory 110 may include multiple physical units, such as one or more primary memory units, such as random-access memory units, one or more secondary data storage units, such as disks, or a combination thereof. For example, the data 112, or a portion thereof, the instructions 114, or a portion thereof, or both, may be stored in a secondary storage unit and may be loaded or otherwise transferred to a primary storage unit in conjunction with processing the respective data 112, executing the respective instructions 114, or both. In some implementations, the memory 110, or a portion thereof, may be removable memory.

The data 112 can include information, such as input audio data, encoded audio data, decoded audio data, or the like. The instructions 114 can include directions, such as code, for performing any method, or any portion or portions thereof, disclosed herein. The instructions 114 can be realized in hardware, software, or any combination thereof. For example, the instructions 114 may be implemented as information stored in the memory 110, such as a computer program, which may be executed by the processor 120 to perform any of the respective methods, algorithms, aspects, or combinations thereof, as described herein.

Although shown as included in the memory 110, in some implementations, the instructions 114, or a portion thereof, may be implemented as a special purpose processor, or circuitry, that can include specialized hardware for carrying out any of the methods, algorithms, aspects, or combinations thereof, as described herein. Portions of the instructions 114 can be distributed across multiple processors on the same machine or different machines or across a network such as a local area network, a wide area network, the Internet, or a combination thereof.

The processor 120 can include any device or system capable of manipulating or processing a digital signal or other electronic information now-existing or hereafter developed, including optical processors, quantum processors, molecular processors, or a combination thereof. For example, the processor 120 can include a special purpose processor, a central processing unit (CPU), a digital signal processor (DSP), a plurality of microprocessors, one or more microprocessor in association with a DSP core, a controller, a microcontroller, an Application Specific Integrated Circuit (ASIC), a Field Programmable Gate Array (FPGA), a programmable logic array, programmable logic controller, microcode, firmware, any type of integrated circuit (IC), a state machine, or any combination thereof. As used herein, the term “processor” includes a single processor or multiple processors.

The user interface 130 can include any unit capable of interfacing with a user, such as a virtual or physical keypad, a touchpad, a display, a touch display, a speaker, a microphone, a video camera, a sensor, or any combination thereof. For example, the user interface 130 may be an audio-visual display device, and the computing device 100 may present audio, such as decoded audio, using the user interface 130 audio-visual display device, such as in conjunction with displaying video, such as decoded video. Although shown as a single unit, the user interface 130 may include one or more physical units. For example, the user interface 130 may include an audio interface for performing audio communication with a user, and a touch display for performing visual and touch-based communication with the user.

The electronic communication unit 140 can transmit, receive, or transmit and receive signals via a wired or wireless electronic communication medium 180, such as a radio frequency (RF) communication medium, an ultraviolet (UV) communication medium, a visible light communication medium, a fiber optic communication medium, a wireline communication medium, or a combination thereof. For example, as shown, the electronic communication unit 140 is operatively connected to an electronic communication interface 142, such as an antenna, configured to communicate via wireless signals.

Although the electronic communication interface 142 is shown as a wireless antenna in FIG. 1, the electronic communication interface 142 can be a wireless antenna, as shown, a wired communication port, such as an Ethernet port, an infrared port, a serial port, or any other wired or wireless unit capable of interfacing with a wired or wireless electronic communication medium 180. Although FIG. 1 shows a single electronic communication unit 140 and a single electronic communication interface 142, any number of electronic communication units and any number of electronic communication interfaces can be used.

The sensor 150 may include, for example, an audio-sensing device, a visible light-sensing device, a motion sensing device, or a combination thereof. For example, 100 the sensor 150 may include a sound-sensing device, such as a microphone, or any other sound-sensing device now existing or hereafter developed that can sense sounds in the proximity of the computing device 100, such as speech or other utterances, made by a user operating the computing device 100. In another example, the sensor 150 may include a camera, or any other image-sensing device now existing or hereafter developed that can sense an image such as the image of a user operating the computing device. Although a single sensor 150 is shown, the computing device 100 may include a number of sensors 150. For example, the computing device 100 may include a first camera oriented with a field of view directed toward a user of the computing device 100 and a second camera oriented with a field of view directed away from the user of the computing device 100.

The power source 160 can be any suitable device for powering the computing device 100. For example, the power source 160 can include a wired external power source interface; one or more dry cell batteries, such as nickel-cadmium (NiCd), nickel-zinc (NiZn), nickel metal hydride (NiMH), lithium-ion (Li-ion); solar cells; fuel cells; or any other device capable of powering the computing device 100. Although a single power source 160 is shown in FIG. 1, the computing device 100 may include multiple power sources 160, such as a battery and a wired external power source interface.

Although shown as separate units, the electronic communication unit 140, the electronic communication interface 142, the user interface 130, the power source 160, or portions thereof, may be configured as a combined unit. For example, the electronic communication unit 140, the electronic communication interface 142, the user interface 130, and the power source 160 may be implemented as a communications port capable of interfacing with an external display device, providing communications, power, or both.

One or more of the memory 110, the processor 120, the user interface 130, the electronic communication unit 140, the sensor 150, or the power source 160, may be operatively coupled via a bus 170. Although a single bus 170 is shown in FIG. 1, a computing device 100 may include multiple buses. For example, the memory 110, the processor 120, the user interface 130, the electronic communication unit 140, the sensor 150, and the bus 170 may receive power from the power source 160 via the bus 170. In another example, the memory 110, the processor 120, the user interface 130, the electronic communication unit 140, the sensor 150, the power source 160, or a combination thereof, may communicate data, such as by sending and receiving electronic signals, via the bus 170.

Although not shown separately in FIG. 1, one or more of the processor 120, the user interface 130, the electronic communication unit 140, the sensor 150, or the power source 160 may include internal memory, such as an internal buffer or register. For example, the processor 120 may include internal memory (not shown) and may read data 112 from the memory 110 into the internal memory (not shown) for processing.

Although shown as separate elements, the memory 110, the processor 120, the user interface 130, the electronic communication unit 140, the sensor 150, the power source 160, and the bus 170, or any combination thereof can be integrated in one or more electronic units, circuits, or chips.

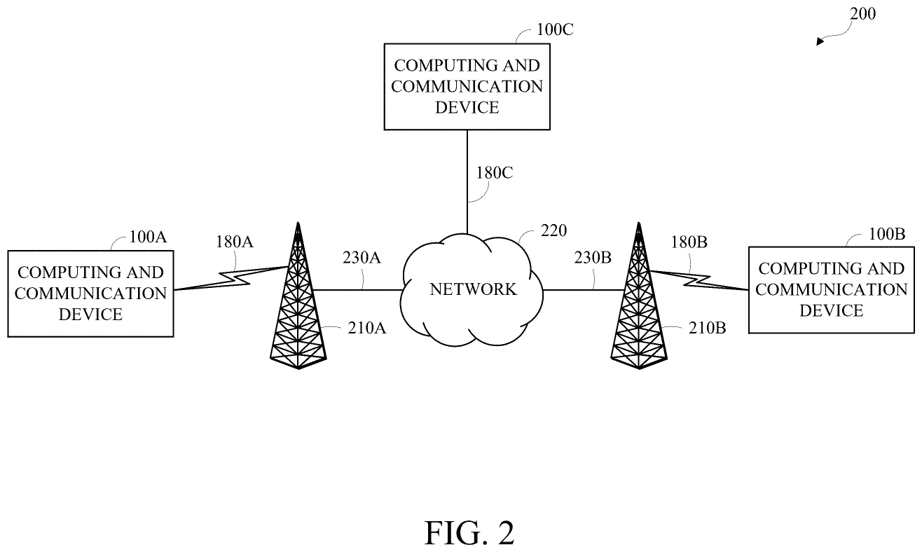

FIG. 2 is a diagram of a computing and communications system 200 in accordance with implementations of this disclosure. The computing and communications system 200 shown includes computing and communication devices 100A, 100B, 100C, access points 210A, 210B, and a network 220. For example, the computing and communication system 200 can be a multiple access system that provides communication, such as voice, audio, data, video, messaging, broadcast, or a combination thereof, to one or more wired or wireless communicating devices, such as the computing and communication devices 100A, 100B, 100C. Although, for simplicity, FIG. 2 shows three computing and communication devices 100A, 100B, 100C, two access points 210A, 210B, and one network 220, any number of computing and communication devices, access points, and networks can be used.

A computing and communication device 100A, 100B, 100C can be, for example, a computing device, such as the computing device 100 shown in FIG. 1. For example, the computing and communication devices 100A, 100B may be user devices, such as a mobile computing device, a laptop, a thin client, or a smartphone, and the computing and communication device 100C may be a server, such as a mainframe or a cluster. Although the computing and communication device 100A and the computing and communication device 100B are described as user devices, and the computing and communication device 100C is described as a server, any computing and communication device may perform some or all of the functions of a server, some, or all, of the functions of a user device, or some or all of the functions of a server and a user device. For example, the server computing and communication device 100C may receive, encode, process, store, transmit, or a combination thereof audio data and one or both of the computing and communication device 100A and the computing and communication device 100B may receive, decode, process, store, present, or a combination thereof the audio data.

Each computing and communication device 100A, 100B, 100C, which may include a user equipment (UE), a mobile station, a fixed or mobile subscriber unit, a cellular telephone, a personal computer, a tablet computer, a server, consumer electronics, or any similar device, can be configured to perform wired or wireless communication, such as via the network 220. For example, the computing and communication devices 100A, 100B, 100C can be configured to transmit or receive wired or wireless communication signals. Although each computing and communication device 100A, 100B, 100C is shown as a single unit, a computing and communication device can include any number of interconnected elements.

Each access point 210A, 210B can be any type of device configured to communicate with a computing and communication device 100A, 100B, 100C, a network 220, or both via wired or wireless communication links 180A, 180B, 180C. For example, an access point 210A, 210B can include a base station, a base transceiver station (BTS), a Node-B, an enhanced Node-B (eNode-B), a Home Node-B (HNode-B), a wireless router, a wired router, a hub, a relay, a switch, or any similar wired or wireless device. Although each access point 210A, 210B is shown as a single unit, an access point can include any number of interconnected elements.

The network 220 can be any type of network configured to provide services, such as voice, data, applications, voice over internet protocol (VOIP), or any other communications protocol or combination of communications protocols, over a wired or wireless communication link. For example, the network 220 can be a local area network (LAN), wide area network (WAN), virtual private network (VPN), a mobile or cellular telephone network, the Internet, or any other means of electronic communication. The network can use a communication protocol, such as the transmission control protocol (TCP), the user datagram protocol (UDP), the internet protocol (IP), the real-time transport protocol (RTP) the HyperText Transport Protocol (HTTP), or a combination thereof.

The computing and communication devices 100A, 100B, 100C can communicate with each other via the network 220 using one or more a wired or wireless communication links, or via a combination of wired and wireless communication links. For example, as shown the computing and communication devices 100A, 100B can communicate via wireless communication links 180A, 180B, and computing and communication device 100C can communicate via a wired communication link 180C. Any of the computing and communication devices 100A, 100B, 100C may communicate using any wired or wireless communication link, or links. For example, a first computing and communication device 100A can communicate via a first access point 210A using a first type of communication link, a second computing and communication device 100B can communicate via a second access point 210B using a second type of communication link, and a third computing and communication device 100C can communicate via a third access point (not shown) using a third type of communication link. Similarly, the access points 210A, 210B can communicate with the network 220 via one or more types of wired or wireless communication links 230A, 230B. Although FIG. 2 shows the computing and communication devices 100A, 100B, 100C in communication via the network 220, the computing and communication devices 100A, 100B, 100C can communicate with each other via any number of communication links, such as a direct wired or wireless communication link.

In some implementations, communications between one or more of the computing and communication device 100A, 100B, 100C may omit communicating via the network 220 and may include transferring data via another medium (not shown), such as a data storage device. For example, the server computing and communication device 100C may store audio data, such as encoded audio data, in a data storage device, such as a portable data storage unit, and one or both of the computing and communication device 100A or the computing and communication device 100B may access, read, or retrieve the stored audio data from the data storage unit, such as by physically disconnecting the data storage device from the server computing and communication device 100C and physically connecting the data storage device to the computing and communication device 100A or the computing and communication device 100B.

Other implementations of the computing and communications system 200 are possible. For example, in an implementation, the network 220 can be an ad-hoc network and can omit one or more of the access points 210A, 210B. The computing and communications system 200 may include devices, units, or elements not shown in FIG. 2. For example, the computing and communications system 200 may include many more communicating devices, networks, and access points.

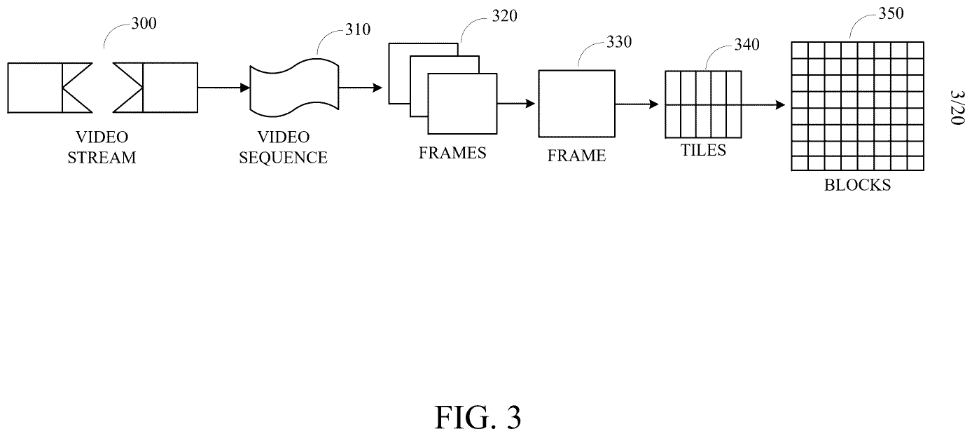

FIG. 3 is a diagram of a video stream 300 for use in encoding and decoding in accordance with implementations of this disclosure. A video stream 300, such as a video stream captured by a video camera or a video stream generated by a computing device, may include a video sequence 310. The video sequence 310 may include a sequence of adjacent frames 320. Although three adjacent frames 320 are shown, the video sequence 310 can include any number of adjacent frames 320.

Each frame 330 from the adjacent frames 320 may represent a single image from the video stream. Although not shown in FIG. 3, a frame 330 may include one or more segments, tiles, or planes, which may be coded, or otherwise processed, independently, such as in parallel. A frame 330 may include one or more tiles 340. Each of the tiles 340 may be a rectangular region of the frame that can be coded independently. Each of the tiles 340 may include respective blocks 350. Although not shown in FIG. 3, a block can include pixels. For example, a block can include a 16×16 group of pixels, an 8×8 group of pixels, an 8×16 group of pixels, or any other group of pixels. Unless otherwise indicated herein, the term ‘block’ can include a superblock, a macroblock, a segment, a slice, or any other portion of a frame. A frame, a block, a pixel, or a combination thereof can include display information, such as luminance information, chrominance information, or any other information that can be used to store, modify, communicate, or display the video stream or a portion thereof.

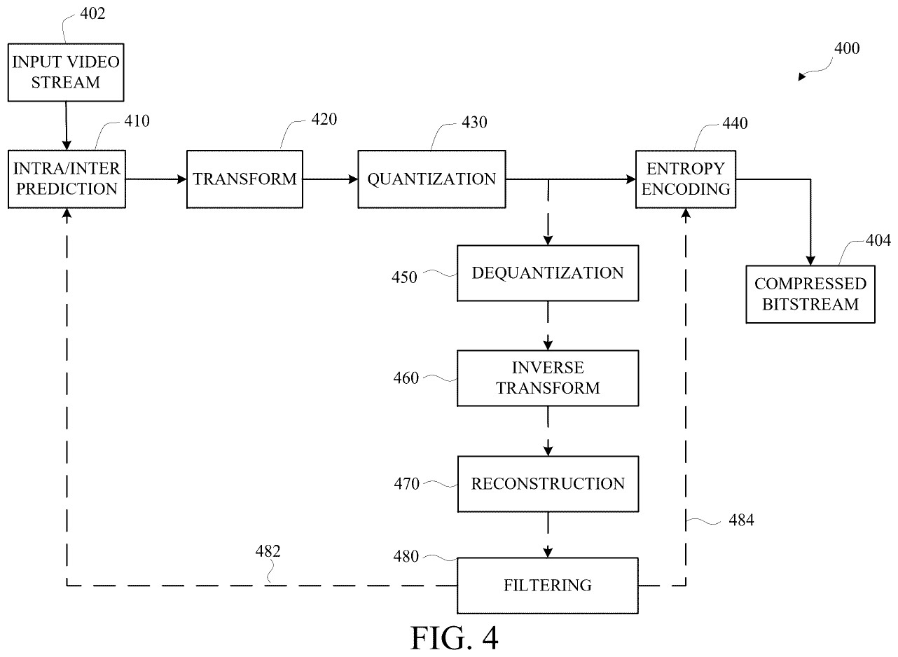

FIG. 4 is a block diagram of an encoder 400 in accordance with implementations of this disclosure. Encoder 400 can be implemented in a device, such as the computing device 100 shown in FIG. 1 or the computing and communication devices 100A, 100B, 100C shown in FIG. 2, as, for example, a computer software program stored in a data storage unit, such as the memory 110 shown in FIG. 1. The computer software program can include machine instructions that may be executed by a processor, such as the processor 120 shown in FIG. 1, and may cause the device to encode video data as described herein. The encoder 400 can be implemented as specialized hardware included, for example, in computing device 100.

The encoder 400 can encode an input video stream 402, such as the video stream 300 shown in FIG. 3, to generate an encoded (compressed) bitstream 404. In some implementations, the encoder 400 may include a forward path for generating the compressed bitstream 404. The forward path may include an intra/inter prediction unit 410, a transform unit 420, a quantization unit 430, an entropy encoding unit 440, or any combination thereof. In some implementations, the encoder 400 may include a reconstruction path (indicated by the broken connection lines) to reconstruct a frame for encoding of further blocks. The reconstruction path may include a dequantization unit 450, an inverse transform unit 460, a reconstruction unit 470, a filtering unit 480, or any combination thereof. Other structural variations of the encoder 400 can be used to encode the video stream 402.

For encoding the video stream 402, each frame within the video stream 402 can be processed in units of blocks. Thus, a current block may be identified from the blocks in a frame, and the current block may be encoded.

At the intra/inter prediction unit 410, the current block can be encoded using either intra-frame prediction, which may be within a single frame, or inter-frame prediction, which may be from frame to frame. Intra-prediction may include generating a prediction block from samples in the current frame that have been previously encoded and reconstructed. Inter-prediction may include generating a prediction block from samples in one or more previously constructed reference frames. Generating a prediction block for a current block in a current frame may include performing motion estimation to generate a motion vector indicating an appropriate reference portion of the reference frame.

The intra/inter prediction unit 410 may subtract the prediction block from the current block (raw block) to produce a residual block. The transform unit 420 may perform a block-based transform, which may include transforming the residual block into transform coefficients in, for example, the frequency domain. Examples of block-based transforms include the Karhunen-Loève Transform (KLT), the Discrete Cosine Transform (DCT), the Singular Value Decomposition Transform (SVD), and the Asymmetric Discrete Sine Transform (ADST). In an example, the DCT may include transforming a block into the frequency domain. The DCT may include using transform coefficient values based on spatial frequency, with the lowest frequency (i.e., DC) coefficient at the top-left of the matrix and the highest frequency coefficient at the bottom-right of the matrix.

The quantization unit 430 may convert the transform coefficients into discrete quantum values, which may be referred to as quantized transform coefficients or quantization levels. The quantized transform coefficients can be entropy encoded by the entropy encoding unit 440 to produce entropy-encoded coefficients. Entropy encoding can include using a probability distribution metric. The entropy-encoded coefficients and information used to decode the block, which may include the type of prediction used, motion vectors, and quantizer values, can be output to the compressed bitstream 404. The compressed bitstream 404 can be formatted using various techniques, such as run-length encoding (RLE) and zero-run coding.

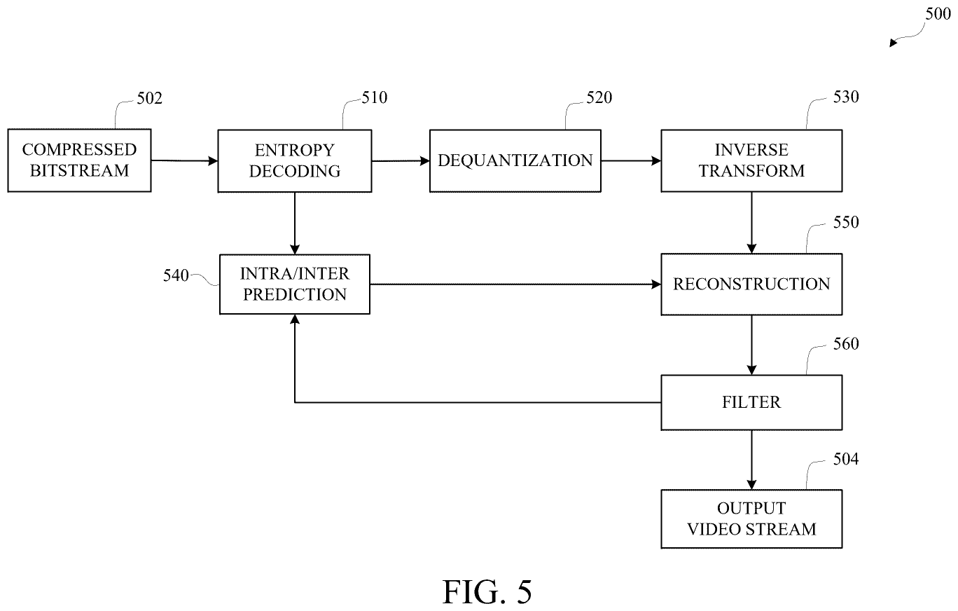

The reconstruction path can be used to maintain reference frame synchronization between the encoder 400 and a corresponding decoder, such as the decoder 500 shown in FIG. 5. The reconstruction path may be similar to the decoding process discussed below and may include decoding the encoded frame, or a portion thereof, which may include decoding an encoded block, which may include dequantizing the quantized transform coefficients at the dequantization unit 450 and inverse transforming the dequantized transform coefficients at the inverse transform unit 460 to produce a derivative residual block. The reconstruction unit 470 may add the prediction block generated by the intra/inter prediction unit 410 to the derivative residual block to create a decoded block. The filtering unit 480 can be applied to the decoded block to generate a reconstructed block, which may reduce distortion, such as blocking artifacts. Although one filtering unit 480 is shown in FIG. 4, filtering the decoded block may include loop filtering, deblocking filtering, or other types of filtering or combinations of types of filtering. The reconstructed block may be stored or otherwise made accessible as a reconstructed block, which may be a portion of a reference frame, for encoding another portion of the current frame, another frame, or both, as indicated by the broken line at 482. Coding information, such as deblocking threshold index values, for the frame may be encoded, included in the compressed bitstream 404, or both, as indicated by the broken line at 484.

Other variations of the encoder 400 can be used to encode the compressed bitstream 404. For example, a non-transform-based encoder 400 can quantize the residual block directly without the transform unit 420. In some implementations, the quantization unit 430 and the dequantization unit 450 may be combined into a single unit.

FIG. 5 is a block diagram of a decoder 500 in accordance with implementations of this disclosure. The decoder 500 can be implemented in a device, such as the computing device 100 shown in FIG. 1 or the computing and communication devices 100A, 100B, 100C shown in FIG. 2, as, for example, a computer software program stored in a data storage unit, such as the memory 110 shown in FIG. 1. The computer software program can include machine instructions that may be executed by a processor, such as the processor 120 shown in FIG. 1, and may cause the device to decode video data as described herein. The decoder 500 can be implemented as specialized hardware included, for example, in computing device 100.

The decoder 500 may receive a compressed bitstream 502, such as the compressed bitstream 404 shown in FIG. 4, and may decode the compressed bitstream 502 to generate an output video stream 504. The decoder 500 may include an entropy decoding unit 510, a dequantization unit 520, an inverse transform unit 530, an intra/inter prediction unit 540, a reconstruction unit 550, a filtering unit 560, or any combination thereof. Other structural variations of the decoder 500 can be used to decode the compressed bitstream 502.

The entropy decoding unit 510 may decode data elements within the compressed bitstream 502 using, for example, Context Adaptive Binary Arithmetic Decoding, to produce a set of quantized transform coefficients. The dequantization unit 520 can dequantize the quantized transform coefficients, and the inverse transform unit 530 can inverse transform the dequantized transform coefficients to produce a derivative residual block, which may correspond to the derivative residual block generated by the inverse transform unit 460 shown in FIG. 4. Using header information decoded from the compressed bitstream 502, the intra/inter prediction unit 540 may generate a prediction block corresponding to the prediction block created in the encoder 400. At the reconstruction unit 550, the prediction block can be added to the derivative residual block to create a decoded block. The filtering unit 560 can be applied to the decoded block to reduce artifacts, such as blocking artifacts, which may include loop filtering, deblocking filtering, or other types of filtering or combinations of types of filtering, and which may include generating a reconstructed block, which may be output as the output video stream 504.

Other variations of the decoder 500 can be used to decode the compressed bitstream 502. For example, the decoder 500 can produce the output video stream 504 without the deblocking filtering unit 560.

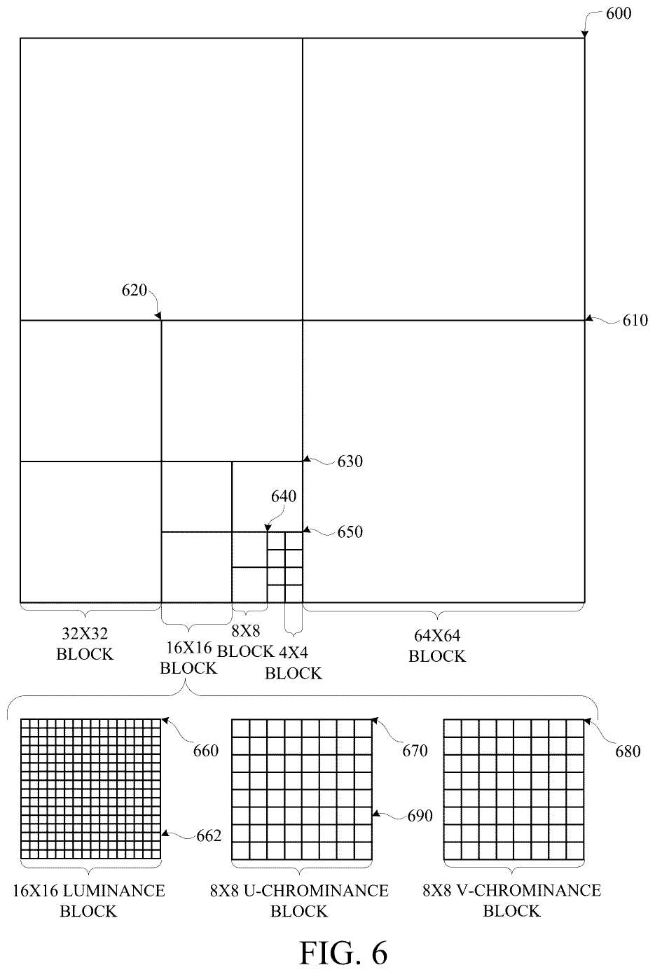

FIG. 6 is a block diagram of a representation of a portion 600 of a frame, such as the frame 330 shown in FIG. 3, in accordance with implementations of this disclosure. As shown, the portion 600 of the frame includes four 64×64 blocks 610, in two rows and two columns in a matrix or Cartesian plane. In some implementations, a 64×64 block may be a maximum coding unit, N=64. Each 64×64 block may include four 32×32 blocks 620. Each 32×32 block may include four 16×16 blocks 630. Each 16×16 block may include four 8×8 blocks 640. Each 8×8 block 640 may include four 4×4 blocks 650. Each 4×4 block 650 may include 16 pixels, which may be represented in four rows and four columns in each respective block in the Cartesian plane or matrix. The pixels may include information representing an image captured in the frame, such as luminance information, color information, and location information. In some implementations, a block, such as a 16×16 pixel block as shown, may include a luminance block 660, which may include luminance pixels 662; and two chrominance blocks 670, 680, such as a U or Cb chrominance block 670, and a V or Cr chrominance block 680. The chrominance blocks 670, 680 may include chrominance pixels 690. For example, the luminance block 660 may include 16×16 luminance pixels 662 and each chrominance block 670, 680 may include 8×8 chrominance pixels 690 as shown. Although one arrangement of blocks is shown, any arrangement may be used. Although FIG. 6 shows N×N blocks, in some implementations, N×M blocks may be used. For example, 32×64 blocks, 64×32 blocks, 16×32 blocks, 32×16 blocks, or any other size blocks may be used. In some implementations, N×2N blocks, 2N×N blocks, or a combination thereof may be used.

In some implementations, video coding may include ordered block-level coding. Ordered block-level coding may include coding blocks of a frame in an order, such as raster-scan order, wherein blocks may be identified and processed starting with a block in the upper left corner of the frame, or portion of the frame, and proceeding along rows from left to right and from the top row to the bottom row, identifying each block in turn for processing. For example, the 64×64 block in the top row and left column of a frame may be the first block coded and the 64×64 block immediately to the right of the first block may be the second block coded. The second row from the top may be the second row coded, such that the 64×64 block in the left column of the second row may be coded after the 64×64 block in the rightmost column of the first row.

In some implementations, coding a block may include using quad-tree coding, which may include coding smaller block units within a block in raster-scan order. For example, the 64×64 block shown in the bottom left corner of the portion of the frame shown in FIG. 6, may be coded using quad-tree coding wherein the top left 32×32 block may be coded, then the top right 32×32 block may be coded, then the bottom left 32×32 block may be coded, and then the bottom right 32×32 block may be coded. Each 32×32 block may be coded using quad-tree coding wherein the top left 16×16 block may be coded, then the top right 16×16 block may be coded, then the bottom left 16×16 block may be coded, and then the bottom right 16×16 block may be coded. Each 16×16 block may be coded using quad-tree coding wherein the top left 8×8 block may be coded, then the top right 8×8 block may be coded, then the bottom left 8×8 block may be coded, and then the bottom right 8×8 block may be coded. Each 8×8 block may be coded using quad-tree coding wherein the top left 4×4 block may be coded, then the top right 4×4 block may be coded, then the bottom left 4×4 block may be coded, and then the bottom right 4×4 block may be coded. In some implementations, 8×8 blocks may be omitted for a 16×16 block, and the 16×16 block may be coded using quad-tree coding wherein the top left 4×4 block may be coded, then the other 4×4 blocks in the 16×16 block may be coded in raster-scan order.

In some implementations, video coding may include compressing the information included in an original, or input, frame by, for example, omitting some of the information in the original frame from a corresponding encoded frame. For example, coding may include reducing spectral redundancy, reducing spatial redundancy, reducing temporal redundancy, or a combination thereof.

In some implementations, reducing spectral redundancy may include using a color model based on a luminance component (Y) and two chrominance components (U and V or Cb and Cr), which may be referred to as the YUV or YCbCr color model, or color space. Using the YUV color model may include using a relatively large amount of information to represent the luminance component of a portion of a frame and using a relatively small amount of information to represent each corresponding chrominance component for the portion of the frame. For example, a portion of a frame may be represented by a high-resolution luminance component, which may include a 16×16 block of pixels, and by two lower resolution chrominance components, each of which represents the portion of the frame as an 8×8 block of pixels. A pixel may indicate a value, for example, a value in the range from 0 to 255, and may be stored or transmitted using, for example, eight bits. Although this disclosure is described in reference to the YUV color model, any color model may be used.

In some implementations, reducing spatial redundancy may include transforming a block into the frequency domain using, for example, a discrete cosine transform (DCT). For example, a unit of an encoder, such as the transform unit 420 shown in FIG. 4, may perform a DCT using transform coefficient values based on spatial frequency.

In some implementations, reducing temporal redundancy may include using similarities between frames to encode a frame using a relatively small amount of data based on one or more reference frames, which may be previously encoded, decoded, and reconstructed frames of the video stream. For example, a block or pixel of a current frame may be similar to a spatially corresponding block or pixel of a reference frame. In some implementations, a block or pixel of a current frame may be similar to block or pixel of a reference frame at a different spatial location and reducing temporal redundancy may include generating motion information indicating the spatial difference, or translation, between the location of the block or pixel in the current frame and corresponding location of the block or pixel in the reference frame.

In some implementations, reducing temporal redundancy may include identifying a portion of a reference frame that corresponds to a current block or pixel of a current frame. For example, a reference frame, or a portion of a reference frame, which may be stored in memory, may be searched to identify a portion for generating a prediction to use for encoding a current block or pixel of the current frame with maximal efficiency. For example, the search may identify a portion of the reference frame for which the difference in pixel values between the current block and a prediction block generated based on the portion of the reference frame is minimized and may be referred to as motion searching. In some implementations, the portion of the reference frame searched may be limited. For example, the portion of the reference frame searched, which may be referred to as the search area, may include a limited number of rows of the reference frame. In an example, identifying the portion of the reference frame for generating a prediction may include calculating a cost function, such as a sum of absolute differences (SAD), between the pixels of portions of the search area and the pixels of the current block.

In some implementations, the spatial difference between the location of the portion of the reference frame for generating a prediction in the reference frame and the current block in the current frame may be represented as a motion vector. The difference in pixel values between the prediction block and the current block may be referred to as differential data, residual data, a prediction error, or as a residual block. In some implementations, generating motion vectors may be referred to as motion estimation, and a pixel of a current block may be indicated based on location using Cartesian coordinates as f_{x, y}. Similarly, a pixel of the search area of the reference frame may be indicated based on location using Cartesian coordinates as r_{x, y}. A motion vector (MV) for the current block may be determined based on, for example, a SAD between the pixels of the current frame and the corresponding pixels of the reference frame.

Although described herein with reference to matrix or Cartesian representation of a frame for clarity, a frame may be stored, transmitted, processed, or any combination thereof, in any data structure such that pixel values may be efficiently represented for a frame or image. For example, a frame may be stored, transmitted, processed, or any combination thereof, in a two-dimensional data structure such as a matrix as shown, or in a one-dimensional data structure, such as a vector array. In an implementation, a representation of the frame, such as a two-dimensional representation as shown, may correspond to a physical location in a rendering of the frame as an image. For example, a location in the top left corner of a block in the top left corner of the frame may correspond with a physical location in the top left corner of a rendering of the frame as an image.

In some implementations, block-based coding efficiency may be improved by partitioning input blocks into one or more prediction partitions, which may be rectangular, including square, partitions for prediction coding. In some implementations, video coding using prediction partitioning may include selecting a prediction partitioning scheme from among multiple candidate prediction partitioning schemes. For example, in some implementations, candidate prediction partitioning schemes for a 64×64 coding unit may include rectangular size prediction partitions ranging in sizes from 4×4 to 64×64, such as 4×4, 4×8, 8×4, 8×8, 8×16, 16×8, 16×16, 16×32, 32×16, 32×32, 32×64, 64×32, or 64×64. In some implementations, video coding using prediction partitioning may include a full prediction partition search, which may include selecting a prediction partitioning scheme by encoding the coding unit using each available candidate prediction partitioning scheme and selecting the best scheme, such as the scheme that produces the least rate-distortion error.

In some implementations, encoding a video frame may include identifying a prediction partitioning scheme for encoding a current block, such as block 610. In some implementations, identifying a prediction partitioning scheme may include determining whether to encode the block as a single prediction partition of maximum coding unit size, which may be 64×64 as shown, or to partition the block into multiple prediction partitions, which may correspond with the sub-blocks, such as the 32×32 blocks 620 the 16×16 blocks 630, or the 8×8 blocks 640, as shown, and may include determining whether to partition into one or more smaller prediction partitions. For example, a 64×64 block may be partitioned into four 32×32 prediction partitions. Three of the four 32×32 prediction partitions may be encoded as 32×32 prediction partitions and the fourth 32×32 prediction partition may be further partitioned into four 16×16 prediction partitions. Three of the four 16×16 prediction partitions may be encoded as 16×16 prediction partitions and the fourth 16×16 prediction partition may be further partitioned into four 8×8 prediction partitions, each of which may be encoded as an 8×8 prediction partition. In some implementations, identifying the prediction partitioning scheme may include using a prediction partitioning decision tree.

In some implementations, video coding for a current block may include identifying an optimal prediction coding mode from multiple candidate prediction coding modes, which may provide flexibility in handling video signals with various statistical properties and may improve the compression efficiency. For example, a video coder may evaluate each candidate prediction coding mode to identify the optimal prediction coding mode, which may be, for example, the prediction coding mode that minimizes an error metric, such as a rate-distortion cost, for the current block. In some implementations, the complexity of searching the candidate prediction coding modes may be reduced by limiting the set of available candidate prediction coding modes based on similarities between the current block and a corresponding prediction block. In some implementations, the complexity of searching each candidate prediction coding mode may be reduced by performing a directed refinement mode search. For example, metrics may be generated for a limited set of candidate block sizes, such as 16×16, 8×8, and 4×4, the error metric associated with each block size may be in descending order, and additional candidate block sizes, such as 4×8 and 8×4 block sizes, may be evaluated.

In some implementations, block-based coding efficiency may be improved by partitioning a current residual block into one or more transform partitions, which may be rectangular, including square, partitions for transform coding. In some implementations, video coding, such as video coding using transform partitioning, may include selecting a uniform transform partitioning scheme. For example, a current residual block, such as block 610, may be a 64×64 block and may be transformed without partitioning using a 64×64 transform.

Although not expressly shown in FIG. 6, a residual block may be transform partitioned using a uniform transform partitioning scheme. For example, a 64×64 residual block may be transform partitioned using a uniform transform partitioning scheme including four 32×32 transform blocks, using a uniform transform partitioning scheme including sixteen 16×16 transform blocks, using a uniform transform partitioning scheme including sixty-four 8×8 transform blocks, or using a uniform transform partitioning scheme including 256 4×4 transform blocks.

In some implementations, video coding, such as video coding using transform partitioning, may include identifying multiple transform block sizes for a residual block using multiform transform partition coding. In some implementations, multiform transform partition coding may include recursively determining whether to transform a current block using a current block size transform or by partitioning the current block and multiform transform partition coding each partition. For example, the bottom left block 610 shown in FIG. 6 may be a 64×64 residual block, and multiform transform partition coding may include determining whether to code the current 64×64 residual block using a 64×64 transform or to code the 64×64 residual block by partitioning the 64×64 residual block into partitions, such as four 32×32 blocks 620, and multiform transform partition coding each partition. In some implementations, determining whether to transform partition the current block may be based on comparing a cost for encoding the current block using a current block size transform to a sum of costs for encoding each partition using partition size transforms.

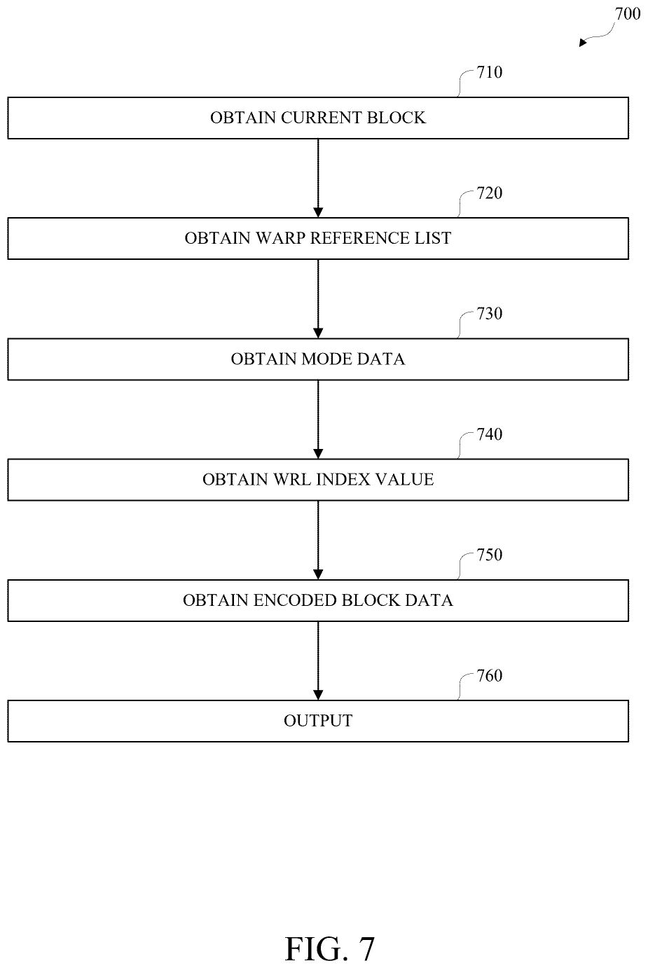

FIG. 7 is a flowchart diagram of an example of encoding using warped motion compensation 700 in accordance with implementations of this disclosure. Encoding using warped motion compensation 700 may be implemented in an encoder, such as the encoder 400 shown in FIG. 4, or one or more portions thereof.

Encoding using warped motion compensation 700 includes encoding an input video steam, such as the input video stream 402 shown in FIG. 4, or one or more portions thereof, to generate an encoded (compressed) output bitstream, such as the encoded (compressed) bitstream 404 shown in FIG. 4, or one or more portions thereof. In block-based hybrid video coding, to reduce, or minimize, the resource utilization, such as bandwidth utilization, for signaling, storing, or both, compressed, or encoded, video data, redundant data, such as spatially redundant data, temporally redundant data, or both, is omitted or excluded from the compressed, or encoded, data. For example, spatial redundancy may be reduced using intra prediction, wherein the current block is predicted from the current frame. In another example, temporal redundancy may be reduced using inter prediction, wherein the current block is predicted from one or more reference frames, which may be previously decoded (and reconstructed) frames, constructed reference frames, or both.

Encoding using warped motion compensation 700 includes generating an encoded bitstream by encoding the current block from the current frame from the input video.

The encoder maintains, such as stores in local memory, such as in a decoded frame buffer (or reference frame buffer, or reconstructed frame buffer), one or more reconstructed frames, which may be used as reference frames for inter prediction. The reconstructed reference frames may include one or more recently output, or displayed, reconstructed frames. The reconstructed reference frames may include one or more previously output, or displayed, reconstructed frames, output, or displayed, prior to outputting, or displaying, the recently output, or displayed, reconstructed frames, such as golden, or key, frames, which may be intra coded frames. The reconstructed reference frames may include one or more frames that are designated as output, or display (displayable) frames. The reconstructed reference frames may include one or more alternate, or constructed, reference frames, which may be non-displayed frames, and which may be synthesized, or constructed, by the encoder, such as using temporal filtering along the motion trajectories of multiple frames.

A reference frame in the reference frame buffer may be identified, or identifiable, using an index value (reference frame index value) with respect to the reference frame buffer wherein a location, or position, in the reference frame buffer is uniquely identifiable by a respective index vale. To reduce, or minimize, the resource utilization, such as bandwidth utilization, for signaling, storing, or both, data identifying the reference frame, or reference frames, used for inter coding, the reference frame, or reference frames, may be expressed, represented, or communicated, by signaling the corresponding reference frame index value. In some implementations, the reference frame index value may be signaled differentially, wherein a difference between the reference frame index value for the current block and a reference frame index value obtained from a neighboring previously coded block is signaled.

Inter prediction includes motion estimation to obtain motion data in accordance with a motion model, such as a translational motion model or a warp motion model. Motion expressed in accordance with a translational motion model may include translational motion vectors that indicate a displacement between a location of a current block in the current frame and a location in the reference frame. In some implementations, motion vectors with respect to multiple reference frames, such as a forward reference frame and a backward reference frame, may be used.

To reduce, or minimize, the resource utilization, such as bandwidth utilization, for signaling, storing, or both, translational motion vectors, the translational motion vectors may be signaled differentially, wherein a difference between a respective translational motion vector for the current block and a reference motion vector (predicted motion vector or motion vector prediction) obtained from one or more context blocks. The context blocks are previously reconstructed blocks spatially neighboring the current block (corresponding to spatial motion vector predictions), or temporally collocated with the current block (corresponding to temporal motion vector predictions).

Spatial, translational, motion vector predictions can be identified from context blocks spatially neighboring the current block in the current frame, including adjacent spatial neighboring blocks, which are direct neighbors of the current block in the current frame, such as blocks above the current block, blocks to the left of the current block, a block above and to the left of the current block, a block above and to the right of the current block, or a combination thereof, and non-adjacent spatial neighboring blocks, such as blocks that are adjacent, such as within a defined distance, such as two rows or two columns, of blocks that are immediately adjacent to the current block. Temporal, translational, motion vector predictions can be identified from one or more collocated context blocks temporally neighboring the current block.

Motion, other than translational motion, which may be inaccurately represented using translational motion vectors, may be expressed in accordance with a warp motion model, such as a homographic warp motion model, an affine warp motion model, a similarity warp motion model, or another warp motion model, such as for warped motion compensation. As used herein, the terms “warp” and “warped” motion refers to non-translational motion, instead of or in addition to translational motion, such as affine motion, homographic motion, or similarity motion, in addition to, or instead of, translational motion. For example, in warped motion compensation, where a current pixel at position (x, y) of a current frame is projected to the position (x′, y′) of a reference frame.

In some implementations, six-parameter warped motion may be referred to as six-parameter affine motion, and a corresponding model may be referred to as a six-parameter affine motion model. In some implementations, a model corresponding to six-parameter warped motion may be referred to as a six-parameter warp motion model. In some implementations, four-parameter warped motion may be referred to as four-parameter affine motion, and a corresponding model may be referred to as a four-parameter affine motion model. In some implementations, a model corresponding to four-parameter warped motion may be referred to as a four-parameter warp motion model. The number, count, or cardinality, of parameters of a warp motion model may be referred to as the cardinality of the model or a cardinality of the model parameters.

A homographic warp motion model includes eight parameters to indicate displacement between pixels of the current block and pixels of the reference frame, such as in a quadrilateral portion of the reference frame, for generating a prediction block. A homographic warp motion model may represent translation, rotation, scaling, changes in aspect ratio, shearing, and other non-parallelogram warping.

An affine warp motion model includes six-parameters to indicate displacement between pixels of the current block and pixels of the reference frame, such as in a parallelogram portion of the reference frame, for generating a prediction block. An affine warp motion model is a linear transformation between the coordinates of two spaces represented by the six-parameters. An affine warp motion model may represent translation, rotation, scale, changes in aspect ratio, and shearing. The parameters of the affine warp motion model include a first pair of parameters (h₁₃, h₂₃) that represent translational motion (translational parameters), such a horizontal translational motion parameter (h₁₃) and a vertical translational motion parameter (h₂₃). The parameters of the affine warp motion model include a second pair of parameters (h₁₁, h₂₂) that represent scaling (scaling parameters), such a horizontal scaling parameter (h₁₁) and a vertical scaling parameter (h₂₂). The parameters of the affine warp motion model include a third pair of parameters (h₁₂, h₂₁) that, in conjunction with the scaling parameters, represent angular rotation (rotation parameters), such as a first rotation parameter (h₁₂) and a second rotation parameter (h₂₁). For example, for a current pixel at position (x, y) from the current frame, a corresponding position (x′, y′) from the reference frame may be indicated using the affine warp motion model, which may include a horizontal displacement (x′) for encoding the current block that is a result of adding a result of multiplying the horizontal scaling parameter by the current horizontal position, a result of multiplying the first rotation parameter by the current vertical position, and the horizontal translational motion parameter, and a vertical displacement (y′) for encoding the current block that is a result of adding a result of multiplying the vertical scaling parameter by the current horizontal position, a result of multiplying the second rotation parameter by the current vertical position, and the vertical translational motion parameter, which may be expressed as the following:

$${x}^{′} = {h}_{11} x + {h}_{12} y + {h}_{13} , \qquad [ Equation 1 ]$$

$${y}^{′} = {h}_{21} x + {h}_{22} y + {h}_{23} . \qquad [ Equation 2 ]$$

A similarity warp motion model includes four-parameters to indicate displacement between pixels of the current block and pixels of the reference frame, such as in a square portion of the reference frame, for generating a prediction block. A similarity warp motion model is a linear transformation between the coordinates of two spaces represented by the four-parameters. For example, the four-parameters can be a translation along the x-axis, a translation along the y-axis, a rotation value, and a zoom value. A similarity warp motion model may represent square-to-square transformation with rotation and zoom. The parameters of the similarity warp motion model include a first pair of parameters (h₁₃, h₂₃) that represent translational motion (translational parameters), such a horizontal translational motion parameter (h₁₃) and a vertical translational motion parameter (h₂₃). The parameters of the similarity warp motion model include a second parameter (h₁₁) that represent scaling (scaling parameter) (h₂₂=h₁₁). The parameters of the similarity warp motion model include a third parameter (h₂₁) that, in conjunction with the scaling parameter, represent angular rotation (rotation parameter) (h₁₂=h₂₁). For example, for a current pixel at position (x, y) from the current frame, a corresponding position (x′, y′) from the reference frame may be indicated using the similarity warp motion model, which may include a horizontal displacement (x′) for encoding the current block that is a result of adding a result of subtracting a result of multiplying the rotation parameter by the current vertical position, from a result of multiplying the horizontal scaling parameter by the current horizontal position, and the horizontal translational motion parameter, and a vertical displacement (y′) for encoding the current block that is a result of adding a result of multiplying the rotation parameter by the current horizontal position, a result of multiplying the horizontal scaling parameter by the current vertical position, and the vertical translational motion parameter, which may be expressed as the following:

$${x}^{′} = {h}_{11} x - {h}_{21} y + {h}_{13} , \qquad [ Equation 3 ]$$

$${y}^{′} = {h}_{21} x + {h}_{11} y + {h}_{23} . \qquad [ Equation 4 ]$$

The parameters of a warp motion model, other than the translational parameters, are non-translational warp motion model parameters.

Block-based hybrid video coding techniques may include warped motion video coding using a global warp motion model, a local warp motion model, or both.

In some implementations, a global warp model, which may represent frame level scaling and rotation, which may correspond with rigid motion, which may be associated with a respective reference frame, may be used, which may include expressing the non-translational parameters (h₁₁, h₁₂, h₂₁, h₂₂) with twelve-bit (12-bit) precision and expressing the translational parameters (h₁₃, h₂₃) with fifteen-bit (15-bit) precision.

In some implementations, a local, block level or causal, warp model (WARP_CAUSAL) may be used. In local warp mode, the warp motion model parameters of the current block are obtained, or derived, by fitting a model to context motion vectors using least-squares. In some implementations, signaling the warp motion model parameters in local warp mode may be omitted, avoided, or excluded.

In an example, in the local warp mode (WARP_CAUSAL), for the current block, a motion vector indicating translational motion is signaled in the encoded bitstream. Rotation and scaling parameters are derived from neighboring motion vectors. The warp motion model parameters are obtained, such as determined or calculated, such as using mean-squared minimization of difference between the reference and modeled projections (projected points in the reference frame) based on motion vectors for the current block and its adjacent neighboring blocks. To obtain the parameters of local warped motion, wherein the current block is coded with respect to a reference frame, for a respective neighboring block coded with respect to the reference frame of the current block, a projection sample pair of a center sample in the neighboring block and a corresponding sample in the reference frame is obtained. The motion vectors of neighboring blocks that refer to the reference frame for the current block are used as motion samples to derive the warp motion model parameters. Warped motion prediction mode may be disable for compound prediction.

In some implementations, warped motion may be coded using an extended warp mode (WARP_EXTEND). In the extended warp mode, a warp motion model is constructed by smoothly extending the motion of the context blocks into the current block, with modification based on a signaled motion vector.

In some implementations, warped motion may be coded using a differential warp motion mode (WARP_DELTA). In the differential warp motion mode (WARP_DELTA), a warp reference list (WRL) is generated from neighboring blocks, such as previously coded, or context, blocks, coded using a warp model. Predicted warp motion model parameters for the current block are obtained from the warp reference list. In some implementations, differential warp motion model parameters indicating a difference between the current, or optimal, warp motion model parameters for the current block and the predicted warp motion model parameters, may be signaled.

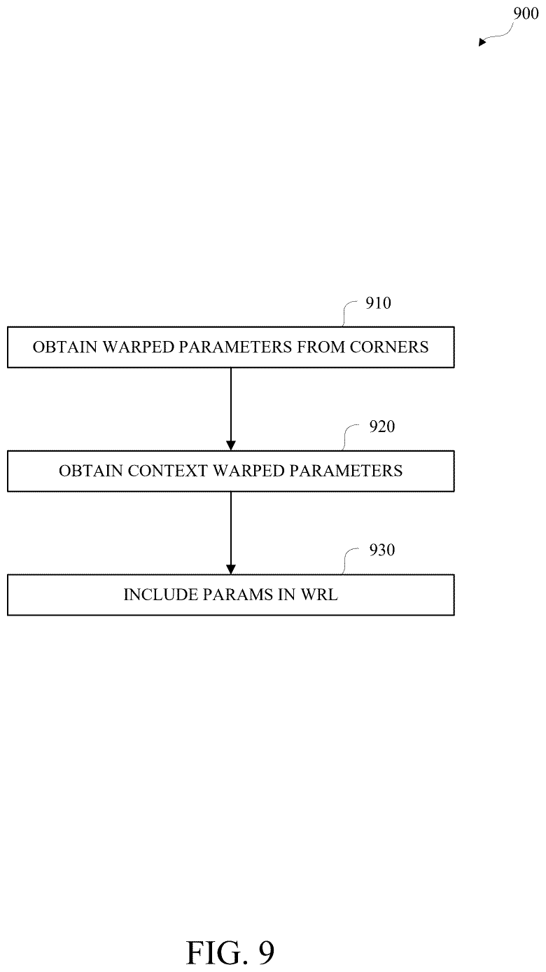

In some implementations, warped motion may be coded using a warp corner motion mode (WARP_CORNER). In warp corner motion mode, three corner motion vectors are obtained, which is similar to obtaining the warp motion model parameters based on one or more corner context blocks as shown in FIG. 9, except as is described herein or as is otherwise clear from context. In warp corner motion mode, three corner motion vectors are in the bit-stream, which may be similar to other motion vector signaling.

In some implementations, generating the warp reference list includes predicting warp motion model parameters from a spatially neighboring blocks, predicting warp motion model parameters from a warp parameter bank, predicting warp motion model parameters from the global motion model, and using defined warp parameter values.

In some implementations, generating the warp reference list includes deriving a warp model from corner context blocks, predicting warp motion model parameters from spatially neighboring blocks, predicting warp motion model parameters from a warp parameter bank, predicting warp motion model parameters from the global motion model, and using defined warp parameter values.

Encoding using warped motion compensation 700 includes obtaining a current block (at 710), obtaining a warp reference list (at 720), obtaining a mode data (at 730), obtaining a warp reference list index value (at 740), obtaining encoded block data (at 750), and outputting an encoded bitstream (at 760).

The current frame is obtained (at 710). The current frame is a frame from the input video, or input video stream. In some implementations, the input video stream may include one or more sequences of frames. A sequence of frames may have a defined cardinality, or number, of frames. For example, the encoder, or a component thereof, such as an intra/inter prediction unit of the encoder, such as the intra/inter prediction unit 410 shown in FIG. 4, may obtain the input video stream. The current frame may be obtained (at 710) subsequent to encoding one or more other frames, such as a frame sequentially preceding the current frame in the input video stream, and generating, or otherwise obtaining, a corresponding reconstructed frame (or frames), or one or more portions thereof, for use as a reference frame (or frames) for encoding the current frame.

The current block is obtained (at 710) from the current frame. Although not shown separately in FIG. 7, encoding using warped motion compensation 700 may include encoding, reconstructing, or both, one or more portions of the current frame prior to encoding the current block.

The warp reference list (WRL) is obtained, such as generated, for the current block (at 720). The warp reference list (WRL) is a list, or array, of warp motion parameter sets obtained, generated, or otherwise accessed, from the context blocks for the current block (at 720).

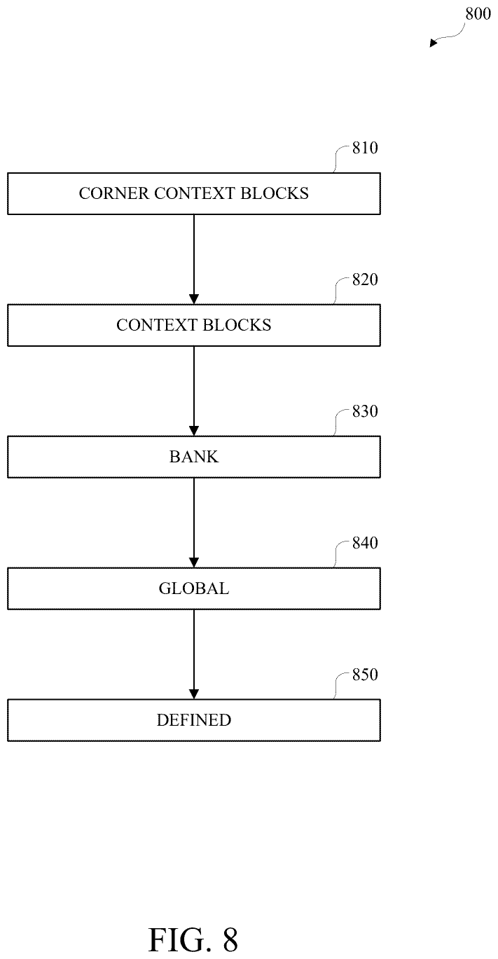

The warp reference list may have a defined, or determined, size, or cardinality, (N), which may be a positive integer value, such as four (N=4). A respective element, record, or row, of the warp reference list includes parameters for a corresponding warp motion model. The warp motion model parameters at a location, or position, in the warp reference list may be indicated, identified, or identifiable, by a warp reference list index value (warp_ref_idx). For example, the cardinality of the warp reference list may be four (N=4) and the warp reference list may include first warp motion model parameters at warp reference list index value zero (0), second warp motion model parameters at warp reference list index value one (1), third warp motion model parameters at warp reference list index value two (2), and fourth warp motion model parameters at warp reference list index value three (3). An example of obtaining a warp reference list is shown in FIG. 8.

The mode data for encoding the current block is obtained (at 730).

Obtaining the mode data includes obtaining, determining, or otherwise identifying prediction mode data for the current block. The prediction mode data for the current block indicates whether the prediction mode for the current block is an intra prediction mode or an inter prediction mode. For encoding using warped motion compensation 700, the prediction mode data for the current block indicates that the prediction mode for the current block is an inter prediction mode. The prediction mode data for the current block indicates whether the prediction mode for the current block is a warp motion vector prediction mode or a prediction mode other than the warp motion vector prediction mode. The warp motion vector prediction mode (WARPMV) is a non-compound inter-prediction mode.

The encoder signals, such as includes in the encoded bitstream, a bit, flag, symbol, data element, or other syntax element, (is_warpmv) to indicate whether the warp motion vector prediction mode (WARPMV) is the prediction mode for the current block.

In some implementations, the prediction mode for the current block is the warp motion vector prediction mode and the encoder signals, such as includes in the encoded bitstream, a bit, flag, symbol, data element, or other syntax element, having a first defined value, such as zero (is_warpmv=0) to indicate that a prediction mode other than the warp motion vector prediction mode (WARPMV) is the prediction mode for the current block.

In some implementations, the prediction mode for the current block is the warp motion vector prediction mode and the encoder signals, such as includes in the encoded bitstream, a bit, flag, symbol, data element, or other syntax element, having a second defined value, such as one (is_warpmv=1) to indicate that the warp motion vector prediction mode (WARPMV) is the prediction mode for the current block.

Obtaining the mode data includes obtaining, determining, or otherwise identifying motion mode data for the current block.

In some implementations, the prediction mode for the current block is the warp motion vector prediction mode (is_warpmv=1) and obtaining, identifying, or determining, the motion mode data (motion_mode) for the current block includes determining whether to encode the current block using a motion mode from one or more candidate motion modes including the causal warp motion mode (WARP_CAUSAL) and the differential warp motion mode (WARP_DELTA). Other motion modes, such as the extended warp motion mode (WARP_EXTEND) and non-warp motion modes may be disabled or unavailable.

In some implementations, the prediction mode for the current block is other than the warp motion vector prediction mode (is_warpmv=0) and obtaining, identifying, or determining, the motion mode data for the current block includes determining whether to encode the current block using a motion mode from one or more candidate motion modes including the causal warp motion mode (WARP_CAUSAL), the differential warp motion mode (WARP_DELTA), the extended warp motion mode (WARP_EXTEND), or a non-warp motion mode, such as a translational motion mode, a compound mode, or the overlapped block motion compensation (OBMC) mode.

The respective rate-distortion error for respective candidate motion modes are determined. The rate-distortion error for a respective motion mode represents the rate cost of encoding the block using the respective motion mode as compared to the distortion cost for encoding the block using the respective motion mode. The motion mode corresponding to the minimal rate-distortion error is identified as the motion mode for the current block.

The encoder signals, such as includes in the encoded bitstream, at least one bit, flag, symbol, data element, or other syntax element, to indicate the motion mode for the current block.

The warp reference list index value (current warp reference list index value, WRL INDEX VALUE, or warp_ref_idx) is obtained (at 740) from the warp reference list. The warp reference list index value corresponds to the predicted warp motion model parameters from the warp reference list.

To obtain, identify, or select, the current warp reference list index value, the encoder searches, or evaluates, the warp motion model parameters from the warp reference list, such as sequentially or in parallel, and identifies the warp reference list index value corresponding to the warp motion model parameters (predicted warp motion model parameters) from the warp reference list that minimizes rate-distortion cost among the warp motion model parameters from the warp reference list. Obtaining the current warp reference list index value may include obtaining the predicted warp motion model parameters from the warp reference list.

In some implementations, such as wherein the prediction mode for the current block is the warp motion vector prediction mode or wherein the motion mode for the current block is the differential warp motion mode (WARP_DELTA), the encoder signals, such as includes in the encoded bitstream, the current warp reference list index value for the current block.

In some implementations, such as wherein the prediction mode for the current block is other than the warp motion vector prediction mode, encoding using warped motion compensation 700 includes obtaining, such as by generating, a list, or array, of translational motion vectors (Dynamic Reference List, DRL, or translational dynamic reference list) generated from the context blocks for the current block. The dynamic reference list includes a list of reference motion vectors, respectively identified, or identifiable, by a corresponding dynamic reference list index value. In some implementations, such as wherein the prediction mode for the current block is other than the warp motion vector prediction mode, encoding using warped motion compensation 700 includes obtaining a reference motion vector index value (ref_mv_idx or ref_drl_idx) with respect to the translational dynamic reference list.

In some implementations, such as wherein the prediction mode for the current block is other than the warp motion vector prediction mode, encoding using warped motion compensation 700 includes including, in the encoded bitstream, the reference motion vector index value (ref_mv_idx or ref_drl_idx) with respect to the translational dynamic reference list.

In some implementations, such as wherein the prediction mode for the current block is the warp motion vector prediction mode, obtaining the translational dynamic reference list may be omitted, excluded, or skipped and signaling the reference motion vector index value (ref_mv_idx or ref_drl_idx) with respect to the translational dynamic reference list may be omitted, excluded, or skipped.

The encoded block data is obtained (at 750). The encoded block data is obtained by encoding the current block using the predicted warp motion model parameters.

Obtaining the encoded block data for the current block includes obtaining a motion vector, such as a translational motion vector or a warp motion vector, for encoding the current block. Obtaining the encoded block data for the current block includes obtaining predicted block data for the current block in accordance with the motion vector. Obtaining the encoded block data for the current block includes obtaining residual block data for the current block indicating a difference between the predicted block data for the current block and the current, or input, block data for the current block.

Obtaining the motion vector for the current block includes obtaining a motion vector prediction for the current block.

In some implementations, such as wherein the prediction mode for the current block is the warp motion vector prediction mode, the motion vector for the current block is a warp motion vector, the motion vector prediction for the current block is a warp motion vector prediction, and the motion vector prediction for the current block is obtained, such as derived, from the warp reference list (WRL), such as in accordance with the warp model, or warp motion parameter set, indicated by the current warp reference list index value (predicted warp motion model parameters).

In some implementations, such as wherein the prediction mode for the current block is other than the warp motion vector prediction mode, the encoder obtains, such as derives, a translational motion vector prediction for the current block from the translational dynamic reference list (DRL), the encoder obtains, such as derives, non-translational motion parameters for the current block from the warp reference list (WRL), and the encoder obtains the warp motion vector for the current block as a combination of the translational motion vector and the non-translational (warp) motion parameters.

In some implementations, such as wherein the prediction mode for the current block is the warp motion vector prediction mode, obtaining the encoded block data using the predicted warp motion model parameters includes determining whether to signal a differential motion vector (motion vector difference value or MVD) for the current block in the encoded bitstream, such as in accordance with minimizing rate-distortion error.

In some implementations, such as wherein the prediction mode for the current block is the warp motion vector prediction mode, obtaining the encoded block data using the predicted warp motion model parameters includes determining whether to signal a bit, flag, symbol, data element, or other syntax element, (warpmv_with_mvd_flag) indicating whether the motion vector difference value is signaled in the encoded bitstream.

Determining whether to signal the bit, flag, symbol, data element, or other syntax element, (warpmv_with_mvd_flag) indicating whether the motion vector difference value is signaled in the encoded bitstream, such as wherein the prediction mode for the current block is the warp motion vector prediction mode, includes determining whether to signal the bit, flag, symbol, data element, or other syntax element, (warpmv_with_mvd_flag) indicating whether the motion vector difference value is signaled in the encoded bitstream in accordance with the current warp reference list index value and a defined threshold, such as two (2). Other values of the defined threshold may be used.

In some implementations, such as wherein the prediction mode for the current block is the warp motion vector prediction mode and the current warp reference list index value is greater than or equal to the defined threshold (warp_ref_idx>=2), the encoder determines that signaling the bit, flag, symbol, data element, or other syntax element, (warpmv_with_mvd_flag) indicating whether the motion vector difference value is signaled in the encoded bitstream is omitted, excluded, or skipped, signaling the bit, flag, symbol, data element, or other syntax element, (warpmv_with_mvd_flag) indicating whether the motion vector difference value is signaled in the encoded bitstream is omitted, excluded, or skipped, signaling the motion vector difference is omitted, excluded, or skipped, and the motion vector prediction is used as the motion vector for the current block.

In some implementations, such as wherein the prediction mode for the current block is the warp motion vector prediction mode and the current warp reference list index value is less than the defined threshold (warp_ref_idx<2), the encoder determines that signaling the bit, flag, symbol, data element, or other syntax element, (warpmv_with_mvd_flag) indicating whether the motion vector difference value is signaled in the encoded bitstream is enabled, and the encoder signals, in the encoded bitstream, the bit, flag, symbol, data element, or other syntax element, (warpmv_with_mvd_flag) indicating whether the motion vector difference value is signaled in the encoded bitstream.

In some implementations, such as wherein the prediction mode for the current block is the warp motion vector prediction mode, the current warp reference list index value is less than the defined threshold (warp_ref_idx<2), the encoder determines that signaling the bit, flag, symbol, data element, or other syntax element, (warpmv_with_mvd_flag) indicating whether the motion vector difference value is signaled in the encoded bitstream is enabled, and the encoder determines that signaling the motion vector difference is omitted, the encoder signals, or otherwise includes, in the encoded bitstream, the bit, flag, symbol, data element, or other syntax element, indicating whether the motion vector difference value is signaled in the encoded bitstream with a first defined value, such as zero, (warpmv_with_mvd_flag=0) indicating that a bitstream element expressly signaling the motion vector difference is omitted, absent, or excluded from the encoded bitstream.

In some implementations, such as wherein the prediction mode for the current block is the warp motion vector prediction mode, the current warp reference list index value is less than the defined threshold (warp_ref_idx<2), the encoder determines that signaling the bit, flag, symbol, data element, or other syntax element, (warpmv_with_mvd_flag) indicating whether the motion vector difference value is signaled in the encoded bitstream is enabled, and the encoder determines that signaling the motion vector difference is enabled, the encoder signals, or otherwise includes, in the encoded bitstream, the bit, flag, symbol, data element, or other syntax element, indicating whether the motion vector difference value is signaled in the encoded bitstream with a second defined value, such as one, (warpmv_with_mvd_flag=1) indicating that the motion vector difference value is signaled, or otherwise included, in the encoded bitstream.

In some implementations, such as wherein the prediction mode for the current block is the warp motion vector prediction mode, the current warp reference list index value is less than the defined threshold (warp_ref_idx<2), the encoder determines that signaling the bit, flag, symbol, data element, or other syntax element, (warpmv_with_mvd_flag) indicating whether the motion vector difference value is signaled in the encoded bitstream is enabled, and the encoder determines that signaling the motion vector difference is enabled, the encoder obtains, determines, or calculates, as the motion vector difference, a difference between the motion vector for the current block and the motion vector prediction for the current block, such as by subtracting the motion vector prediction for the current block from the motion vector for the current block, and the encoder signals, or otherwise includes, in the encoded bitstream, the motion vector difference value for the current block, which may be similar to signaling the motion vector difference in a translational motion mode, except as is described herein or as is otherwise clear from context.

Although not shown separately in FIG. 7, in some implementations, prior to encoding the current frame, or a block thereof, the encoder may signal, such as include in the encoded bitstream, a frame level flag, bit, symbol, data element, or other syntax element, to indicate whether the warp motion vector prediction mode is enabled, available, or usable, for the current frame or is disabled, unavailable, or unusable for the current frame.

In some implementations, such as wherein the prediction mode for the current block is other than the warp motion vector prediction mode, the motion mode for the current block is the differential warp motion mode (WARP_DELTA), and the frame level flag, bit, symbol, data element, or other syntax element, indicating whether the warp motion vector prediction mode is enabled, available, or usable, for the current frame indicates that the warp motion vector prediction mode is enabled, available, or usable, for the current frame, obtaining the encoded block data for the current block (at 750) includes obtaining current, or optimal, warp motion model parameters for the current block, which may differ from the predicted warp motion model parameters for the current block.

To obtain, or identify, the current warp motion model parameters for the current block, the encoder may search, or evaluate, parameter values around the predicted warp motion model parameters, such as using a spiral search or a gradient descent search. At a respective search point, the encoder may determine a corresponding rate-distortion metric, or cost. The encoder may identify the parameters corresponding to the minimal rate-distortion cost as the current, or optimal, warp motion model parameters for the current block.

In some implementations, such as wherein the prediction mode for the current block is other than the warp motion vector prediction mode, the motion mode for the current block is the differential warp motion mode (WARP_DELTA), and the frame level flag, bit, symbol, data element, or other syntax element, indicating whether the warp motion vector prediction mode is enabled, available, or usable, for the current frame indicates that the warp motion vector prediction mode is enabled, available, or usable, for the current frame, obtaining the encoded block data for the current block (at 750) includes obtaining, such as generating, calculating, or determining, differential warp motion model parameters.

In some implementations, obtaining the differential warp motion model parameters includes obtaining, on a per-parameter basis, a difference, or delta, (Δhₘₙ) between the current, or optimal, warp model parameter for the current block (hₘₙ) from the current, or optimal, warp motion model parameters and the corresponding predicted warp model parameter (h′ₘₙ) from the predicted warp motion model parameters, wherein 1≤m, n≤2 for a six-parameter affine warp motion model or 1≤m≤2, n=1 for a four-parameter similarity warp motion model, which may be expressed as the following:

$$Δ {h}_{m n} = {h}_{m n} - {{h}^{′}}_{m n} . \qquad [ Equation 5 ]$$

In some implementations, such as wherein the prediction mode for the current block is other than the warp motion vector prediction mode, the motion mode for the current block is the differential warp motion mode (WARP_DELTA), the warp reference list index value (WRL INDEX VALUE or warp_ref_idx) for the current block is one (warp_ref_idx=1), and the frame level flag, bit, symbol, data element, or other syntax element, indicating whether the warp motion vector prediction mode is enabled, available, or usable, for the current frame indicates that the warp motion vector prediction mode is enabled, available, or usable, for the current frame, obtaining the encoded block data for the current block (at 750) includes signaling, in the encoded bitstream, the differential warp motion model parameters.

In some implementations, such as wherein the prediction mode for the current block is the warp motion vector prediction mode, the motion mode for the current block is the other than the differential warp motion mode (WARP_DELTA), the warp reference list index value (WRL INDEX VALUE or warp_ref_idx) for the current block is other than one (warp_ref_idx!=1), or the frame level flag, bit, symbol, data element, or other syntax element, indicating whether the warp motion vector prediction mode is enabled, available, or usable, for the current frame indicates that the warp motion vector prediction mode is disabled, unavailable, or unusable, for the current frame, obtaining the encoded block data for the current block (at 750) omits, skips, avoids, or excludes obtaining and signaling the differential warp motion model parameters, such that the differential warp motion model parameters are omitted, absent, or excluded, from the encoded bitstream, and the predicted warp motion model parameters for the current block are used as the warp motion model parameters for the current block.

FIG. 8 is a flowchart diagram of an example of obtaining a warp reference list 800 in accordance with implementations of this disclosure. Obtaining the warp reference list 800 may be implemented in an encoder, such as the encoder 400 shown in FIG. 4, or a decoder, such as the decoder 500 shown in FIG. 5. Obtaining the warp reference list 800 is similar to obtaining a warp reference list as shown (at 720) in FIG. 7, except as is described herein or as is otherwise clear from context.

Obtaining the warp reference list 800 includes populating, generating, or otherwise obtaining, the warp reference list based on, in accordance with, or using, corner context blocks (at 810), one or more context blocks (at 820), a warp motion parameter bank (at 830), global warp motion model parameters (at 840), and defined warp motion model parameters (at 850).

Obtaining the warp reference list 800 includes obtaining zero or more sets of derived warp motion model parameters based on, in accordance with, or using, corner context blocks (at 810) (corner derived warp motion model parameters). An example of obtaining derived warp motion model parameters based on, in accordance with, or using, corner context blocks (at 810) is shown in FIG. 9.

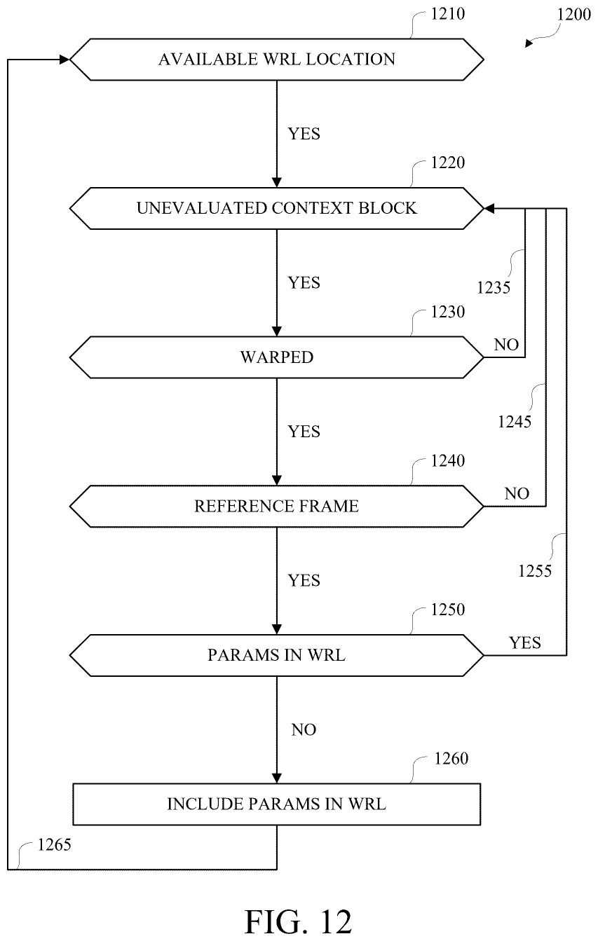

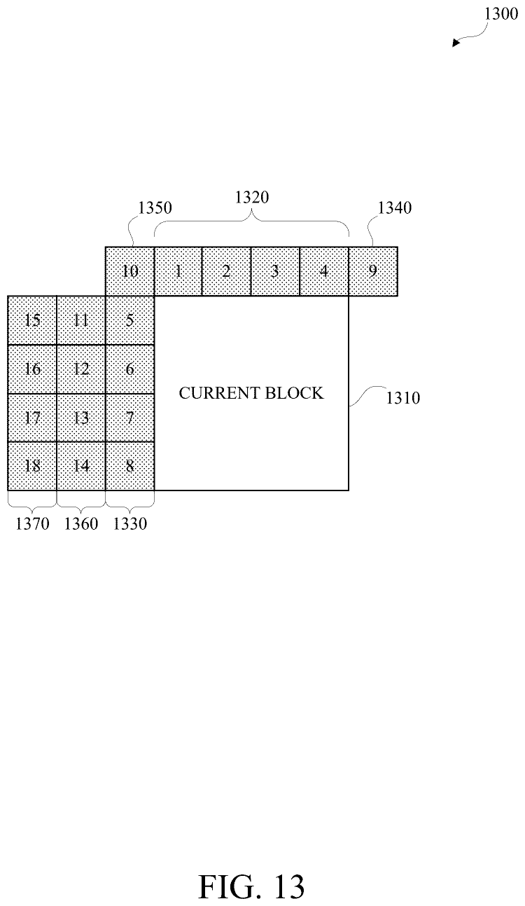

Obtaining the warp reference list 800 includes obtaining zero or more sets of derived warp motion model parameters based on one or more context blocks (at 820) in accordance with a defined sequence of context blocks (context derived warp motion model parameters). An example of obtaining derived warp motion model parameters based on one or more context blocks is shown in FIG. 12. An example of a defined sequence of context blocks is shown in FIG. 13.

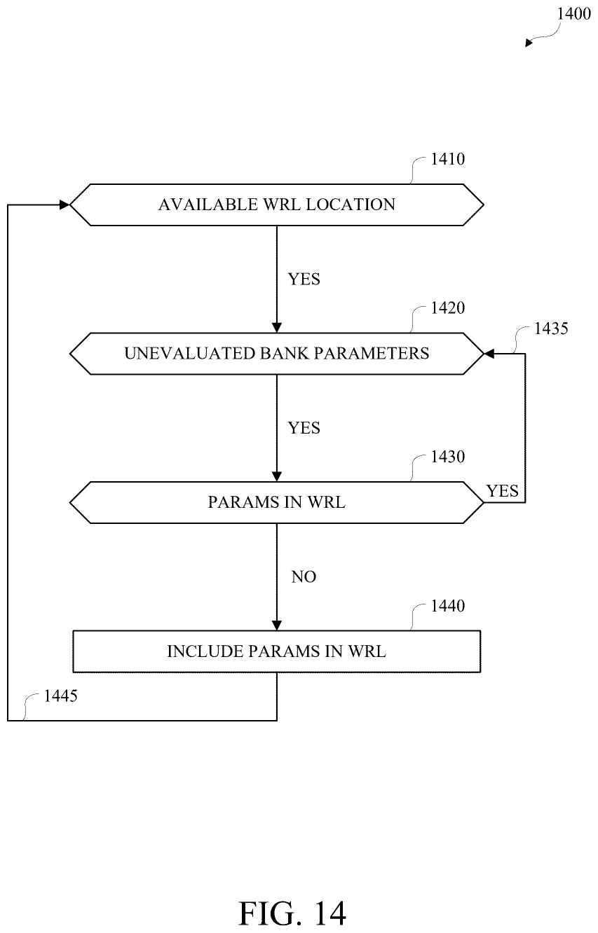

Obtaining the warp reference list 800 includes obtaining zero or more sets of warp motion model parameters based on the warp motion parameter bank (at 830). An example of obtaining warp motion model parameters based on the warp motion parameter bank is shown in FIG. 14.

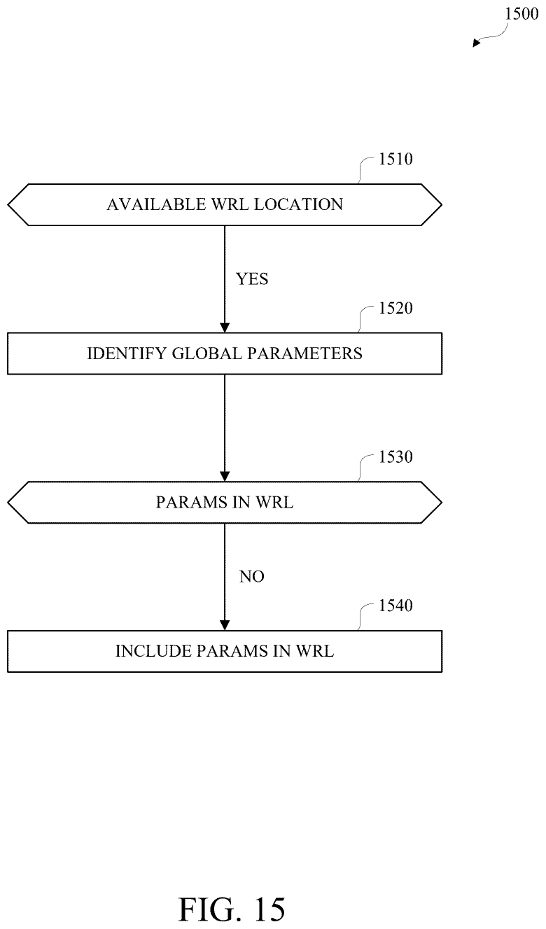

Obtaining the warp reference list 800 includes obtaining zero or more sets of warp motion model parameters based on global warp motion model parameters (at 840). An example of obtaining warp motion model parameters based on global warp motion model parameters is shown in FIG. 15.

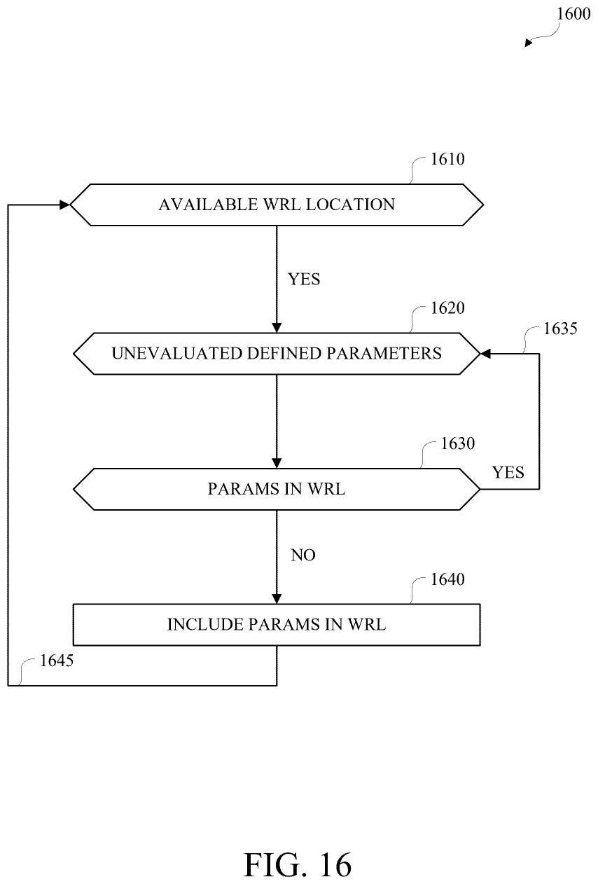

Obtaining the warp reference list 800 includes obtaining zero or more sets of warp motion model parameters based on defined warp motion model parameters (at 850). An example of obtaining warp motion model parameters based on defined warp motion model parameters is shown in FIG. 16.

FIG. 9 is a flowchart diagram of an example of obtaining derived warp motion model parameters based on one or more corner context blocks 900 in accordance with implementations of this disclosure. Obtaining derived warp motion model parameters based on one or more corner context blocks 900 may be implemented in an encoder, such as the encoder 400 shown in FIG. 4, or a decoder, such as the decoder 500 shown in FIG. 5.

Implementations of coding using a warp model using neighboring motion include obtaining, such as deriving, a warp model from previously decoded neighboring, or context, motion vectors (MVs) for coding the current block. FIG. 9 shows an example of obtaining, such as deriving, a warp model from previously decoded neighboring, or context, motion vectors (MVs) for coding the current block.

Obtaining derived warp motion model parameters based on one or more corner context blocks 900 includes obtaining context warp motion model parameters from one or more corner context blocks (at 910), obtaining the derived warp motion model parameters (at 920), and including the derived warp motion model parameters in the warp reference list (at 930).

The encoder, or a component thereof, or the decoder, or a component thereof obtains the context warp motion model parameters from one or more corner context blocks (at 910).

The current block includes a top-left pixel position (x0, y0), a top-right pixel position (x1, y1), and a bottom-left pixel position (x2, y2). The current block has a height (H) and a width (W).

A projected block in, or obtained, such as generated, from, a reference for coding the current block 1010 includes a top-left pixel position (x0′, y0′), a top-right pixel position (x1′, y1′), and a bottom-left pixel position (x2′, y2′).

The corner context blocks include a top-left previously decoded neighboring, or context, block (A) above and to the left of the current block in the current frame, a top-right previously decoded neighboring, or context, block (B) above and at the right edge of the current block in the current frame, and a bottom-left previously decoded neighboring, or context, block (C), to the left of and at the bottom edge of the current block in the current frame.

A first reference, neighboring, or context, motion vector (MV0) used to code the top-left previously decoded neighboring, or context, block (A or first reference block) is obtained from the top-left previously decoded neighboring, or context, block (A). The first reference, neighboring, or context, motion vector (MV0 or top-left corner context motion vector) includes a horizontal component (MV0x) and a vertical component (MV0y).

A second reference, neighboring, or context, motion vector (MV1) used to code the top-right previously decoded neighboring, or context, block (B or second reference block) is obtained from the top-right previously decoded neighboring, or context, block (B). The second reference, neighboring, or context, motion vector (MV1 or top-right corner context motion vector) includes a horizontal component (MV1x) and a vertical component (MV1y).

A third reference, neighboring, or context, motion vector (MV2) used to code the bottom-left previously decoded neighboring, or context, block (C or third reference block) is obtained from the bottom-left previously decoded neighboring, or context, block (C). The third reference, neighboring, or context, motion vector (MV2 or bottom-left corner context motion vector) includes a horizontal component (MV2x) and a vertical component (MV2y).

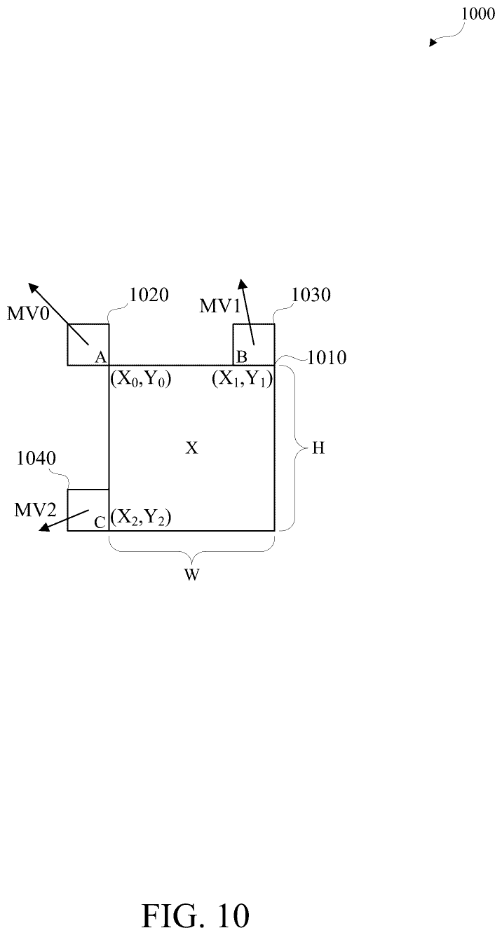

An example of corner context blocks is shown in FIG. 10.

The encoder, or a component thereof, or the decoder, or a component thereof obtains the derived warp motion model parameters (at 920).

A projected block obtained, such as generated, from a reference frame for coding the current block 1010 includes a top-left pixel position (x0′, y0′), a top-right pixel position (x1′, y1′), and a bottom-left pixel position (x2′, y2′).

Obtaining the positions of projected samples (x0′, y0′), (x1′, y1′), and (x2′, y2′), for coding the current block 1010, can be expressed as follows:

$$x {0}^{′} = x 0 + MV 0 x$$

$$y {0}^{′} = y 0 + MV 0 y$$

$$x {1}^{′} = x 1 + MV 1 x$$

$$y {1}^{′} = y 1 + MV 1 y$$

$$x {2}^{′} = x 2 + MV 2 x$$

$$y {2}^{′} = y2 + MV 2 y .$$

Using the respective values of the projected samples (x0′, y0′), (x1′, y1′), and (x2′, y2′), in equations (1) and (2), and with simplification, the warp motion model parameters can be obtained, generated, or derived, which can be expressed as follows:

$${h}_{11} = \frac{x {1}^{′} - x 0}{W}$$

$${h}_{21} = \frac{y {1}^{′} - y 0}{W}$$

$${h}_{12} = \frac{x {2}^{′} - x 0}{H}$$

$${h}_{22} = \frac{y {2}^{′} - y0}{H}$$

$${h}_{13} = x {0}^{′} - {h}_{11} x 0 + {h}_{12} y 0$$

$${h}_{23} = y {0}^{′} - {h}_{21} x 0 + {h}_{22} y 0.$$

As indicated above, in some implementations, obtaining the derived warp motion model parameters includes obtaining, as the horizontal scaling parameter (h₁₁) of the derived warp motion model parameters, the result of dividing the result of subtracting the horizontal location (x0) in the current frame of the top-left corner pixel of the current block from the sum (x1′) of the horizontal location (x1) in the current frame of the top-right corner pixel of the current block and the horizontal component (MV1x) of the top-right corner context motion vector by the width (W) of the current block; obtaining, as the first rotation parameter (h₁₂) of the derived warp motion model parameters, the result of dividing the result of subtracting the horizontal location (x0) in the current frame of the top-left corner pixel of the current block from the sum (x2′) of the horizontal location (x2) in the current frame of the bottom-left corner pixel of the current block and the horizontal component (MV2x) of the bottom-left corner context motion vector by the height (H) of the current block; obtaining, as the second rotation parameter (h₂₁) of the derived warp motion model parameters, the result of dividing the result of subtracting the vertical location (y0) in the current frame of the top-left corner pixel of the current block from the sum (y1′) of the vertical location (y1) in the current frame of the top-right corner pixel of the current block and the vertical component (MV1y) of the top-right corner context motion vector by the width (W) of the current block; obtaining, as the vertical scaling parameter (h₂₂) of the derived warp motion model parameters, the result of dividing the result of subtracting the vertical location (y0) in the current frame of the top-left corner pixel of the current block from the sum (y2′) of the vertical location (y2) in the current frame of the bottom-left corner pixel of the current block and the vertical component (MV2y) of the bottom-left corner context motion vector by the height of the current block; obtaining, as the horizontal translational motion parameter (h₁₃) of the derived warp motion model parameters, the sum of the result of subtracting, from the sum (x0′) of the horizontal location (x0) in the current frame of the top-left corner pixel of the current block and the horizontal component (MV0x) of the top-left corner context motion vector, the result of multiplying the horizontal scaling parameter (h₁₁) by the horizontal location (x0) in the current frame of the top-left corner pixel of the current block and the result of multiplying the first rotation parameter (h₁₂) by the vertical location (y0) in the current frame of the top-left corner pixel of the current block; and obtaining, as the vertical translational motion parameter (h₂₃) of the derived warp motion model parameters, the sum of the result of subtracting, from the sum (y0′) of the vertical location (y0) in the current frame of the top-left corner pixel of the current block and the vertical component (MV0y) of the top-left corner context motion vector, the result of multiplying the second rotation parameter (h₂₁) by the horizontal location (x0) in the current frame of the top-left corner pixel of the current block and the result of multiplying the vertical scaling parameter (h₂₂) by the vertical location (y0) in the current frame of the top-left corner pixel of the current block.

In another example, obtaining the projected samples using a six-parameter affine warp motion model may be expressed as the following:

$${x}^{′} = m 2 x + m 3 y + m 0 , \qquad [ Equation 6 ]$$

$${y}^{′} = m 4 x + m 5 y + m 1. \qquad [ Equation 7 ]$$

With respect to equations (6) and (7), obtaining the parameters of the six-parameter affine warp motion model may be expressed as the following:

$$m 2 = ( x {1}^{′} - x 0 ) ≫ log 2 ( W )$$

$$m 4 = ( y {1}^{′} - y 0 ) ≫ log 2 ( W )$$

$$m 3 = ( x {2}^{′} - x 0 ) ≫ log 2 ( H )$$

$$m 5 = ( y {2}^{′} - y 0 ) ≫ log 2 ( H )$$

$$m 0 = x {0}^{′} - m 2 x 0 + m 3 y 0$$

$$m 1 = y {0}^{′} - m 4 x 0 + m 5 y 0.$$

The derived warp motion model parameters (h₁₁, h₁₂, h₁₃, h₂₁, h₂₂, h₂₃) are obtained, generated, or derived, from the previously decoded neighboring motion vectors of the top-left previously decoded neighboring, or context, block (A), the top-right previously decoded neighboring, or context, block (B), and the bottom-left previously decoded neighboring, or context, block (C).

In some implementations, one or more of the top-left previously decoded neighboring, or context, block (A), the top-right previously decoded neighboring, or context, block (B), and the bottom-left previously decoded neighboring, or context, block (C) may be decoded from one or more different reference frames, differing from the reference frame for coding the current block.

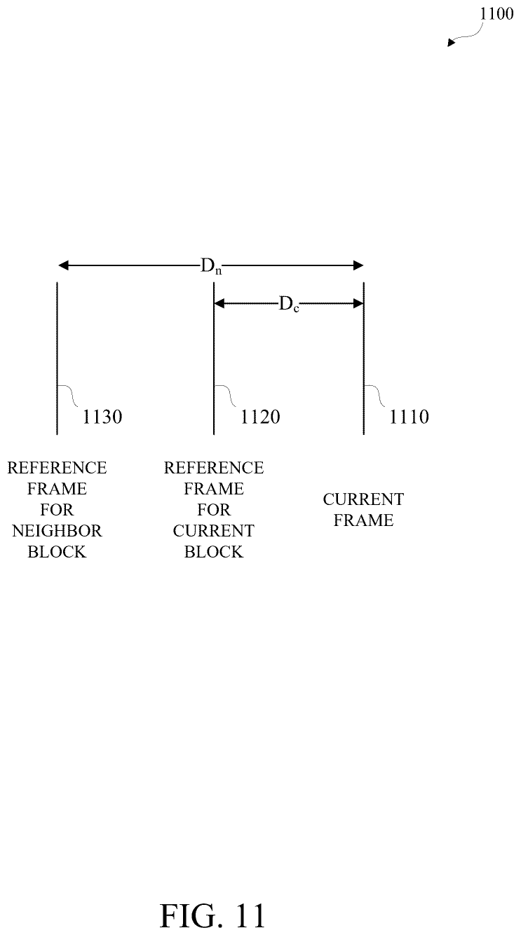

In some implementations, wherein one or more of the top-left previously decoded context, or neighboring, block (A), the top-right previously decoded context, or neighboring, block (B), and the bottom-left previously decoded context, or neighboring, block (C) is coded with reference to one or more different reference frames, differing from the reference frame for coding the current block, and the motion vector values are scaled and projected to the reference of the current block by using the distance between the current frames and the reference frames. An example of reference frame location differences is shown in FIG. 11.

In some implementations, wherein one or more of the top-left previously decoded context, or neighboring, block (A), the top-right previously decoded context, or neighboring, block (B), and the bottom-left previously decoded context, or neighboring, block (C) is coded with reference to one or more different reference frames, differing from the reference frame for coding the current block, obtaining the respective positions of the projected samples (x0′, y0′), (x1′, y1′), and (x2′, y2′), with respect to a distance (D_{c}) between the current frame and the reference frame for coding the current block and a distance (Dₙ) between the current frame and the reference frame of the respective corner context, or neighboring, block, may be expressed as the following:

$$x {0}^{′} = x 0 + \frac{{D}_{c}}{{D}_{n}} \times MV {0}_{x}$$

$$y {0}^{′} = y 0 + \frac{{D}_{c}}{{D}_{n}} \times MV {0}_{y}$$

$$x {1}^{′} = x 1 + \frac{{D}_{c}}{{D}_{n}} \times MV {1}_{x}$$

$$y {1}^{′} = y 1 + \frac{{D}_{c}}{{D}_{n}} \times MV {1}_{y}$$

$$x {2}^{′} = x 2 + \frac{{D}_{c}}{{D}_{n}} \times MV {2}_{x}$$

$$y {2}^{′} = y 2 + \frac{{D}_{c}}{{D}_{n}} \times MV {2}_{y .}$$

In some implementations, wherein one or more of the top-left previously decoded context, or neighboring, block (A), the top-right previously decoded context, or neighboring, block (B), and the bottom-left previously decoded context, or neighboring, block (C) is coded with reference to one or more different reference frames, differing from the reference frame for coding the current block, and obtaining warp motion model parameters based on one or more corner context blocks 900 may be omitted, avoided, or excluded.

In some implementations, one or more of the top-left previously decoded context, or neighboring, block (A), the top-right previously decoded context, or neighboring, block (B), and the bottom-left previously decoded context, or neighboring, block (C) is unavailable for coding the current block. For example, a context, or neighboring, block that is outside of a frame boundary or a tile boundary or coded as intra prediction mode may be unavailable such that valid motion information is unavailable for the context, or neighboring, block for coding the current block, and obtaining warp motion model parameters based on one or more corner context blocks 900 may be omitted, avoided, or excluded.

The encoder, or a component thereof, or the decoder, or a component thereof includes the derived warp motion model parameters (obtained at 920) in the warp reference list (at 930). The derived warp motion model parameters are included in the warp reference list (at 930) at a sequentially minimal index location available in the warp reference list, such as the first index location, having the index value zero (0), in the warp reference list.

FIG. 10 is a block diagram of an example of corner context blocks 1000 in accordance with implementations of this disclosure.

FIG. 10 shows a current block (X) 1010 of a current frame. The current block (X) 1010 includes a top-left pixel position (x0, y0), a top-right pixel position (x1, y1), and a bottom-left pixel position (x2, y2). The current block 1010 has a height (H) and a width (W).

FIG. 10 shows a top-left previously decoded neighboring block (A) 1020, a top-right previously decoded neighboring block (B) 1030, and a bottom-left previously decoded neighboring block (C) 1040.

FIG. 10 shows corner context motion vectors including a first reference, neighboring, or context, motion vector (MV0) used to code the top-left previously decoded neighboring block (A) 1020, a second reference, neighboring, or context, motion vector (MV1) used to code the top-right previously decoded neighboring block (B) 1030, and a third reference, neighboring, or context, motion vector (MV2) used to code the bottom-left previously decoded neighboring block (C) 1040.

FIG. 11 is a block diagram of an example of reference frame location differences 1100 in accordance with implementations of this disclosure.

FIG. 11 shows a distance (D_{c}), such as one (1), between a current frame 1110 and a reference frame 1120 for coding a current block.

FIG. 11 shows a distance (Dₙ), such as two (2), between the current frame 1110 and a reference frame 1130 of a corner context, or neighboring, block, such as the top-left previously decoded context, or neighboring, block (A), of the current block.

FIG. 12 is a flowchart diagram of an example of obtaining warp motion model parameters based on one or more context blocks 1200 in accordance with implementations of this disclosure. Obtaining warp motion model parameters based on one or more context blocks 1200 may be implemented in an encoder, such as the encoder 400 shown in FIG. 4, or a decoder, such as the decoder 500 shown in FIG. 5.

Obtaining warp motion model parameters based on one or more context blocks 1200 includes determining that an index location is available in the warp reference list (at 1210), determining whether an unevaluated context block is available (at 1220), determining that the unevaluated context block is coded using a warped motion prediction mode (at 1230), determining that the unevaluated context block is coded with reference to a current reference frame (at 1240), determining that warp motion model parameters from the unevaluated context block differ from the warp motion model parameters in the warp reference list (at 1250), and including the warp motion model parameters from the unevaluated context block in the warp reference list (at 1260).

The encoder, or a component thereof, or the decoder, or a component thereof determines that an, or at least one, index location is available, unpopulated, or empty, in the warp reference list (at 1210), which includes determining whether an index location is available, unpopulated, or empty, in the warp reference list, wherein the index location is the sequentially, such as in increasing warp reference list index value order, minimal, or earliest, available, unpopulated, or empty, index location. For example, the warp reference list may include derived warp motion model parameters obtained from corner context blocks, such as shown in FIG. 9, in the first location, or position, in the warp reference list corresponding to the warp reference list index value zero (0), the other locations in the warp reference list may be available, and the index location corresponding to the index value one (1) is identified as the sequentially minimal index location available in the warp reference list. In some implementations, the encoder, or a component thereof, or the decoder, or a component thereof may determine that an index location is unavailable in the warp reference list, such as wherein the index locations of the warp reference list include respective warp motion model parameters, and obtaining warp motion model parameters based on one or more context blocks 1200 may be otherwise omitted, avoided, or excluded.

In response to determining that the sequentially minimal index location is available, unpopulated, or empty, in the warp reference list (at 1210), the encoder, or a component thereof, for encoding, or the decoder, or a component thereof, for decoding, determines that an unevaluated context block is available (at 1220), which includes determining whether an unevaluated context block is available among the context blocks for the current block. Determining that the unevaluated context block is available includes evaluating the context blocks for the current block in a defined sequence, or order, such as the sequence shown in FIG. 13. The unevaluated context block is a context block from the context blocks for the current block, other than context blocks from the context blocks for the current block previously evaluated in accordance with obtaining warp motion model parameters based on one or more context blocks 1200 for the current block, that is the sequentially minimal, in the defined sequence, unevaluated context block (the sequentially minimal unevaluated context block). In some implementations, the encoder, or a component thereof, for encoding, or the decoder, or a component thereof, for decoding, may determine that an unevaluated context block is unavailable among the context blocks for the current block, such as wherein the context blocks for the current block were previously evaluated in accordance with obtaining warp motion model parameters based on one or more context blocks 1200 for the current block, and obtaining warp motion model parameters based on one or more context blocks 1200 may be otherwise omitted, avoided, or excluded.

In response to determining that the unevaluated context block is available (at 1220), the encoder, or a component thereof, for encoding, or the decoder, or a component thereof, for decoding, determines that the unevaluated context block is coded using a warped motion prediction mode (at 1230), which includes determining whether the unevaluated context block is coded using a warped motion prediction mode. In some implementations, the encoder, or a component thereof, for encoding, or the decoder, or a component thereof, for decoding, may determine that the unevaluated context block is coded using a motion prediction mode other than a warped motion prediction mode, such as the translational motion prediction mode, the current unevaluated context block may be identified as an evaluated context block, and the encoder, or a component thereof, for encoding, or the decoder, or a component thereof, for decoding, may determine whether another unevaluated context block is available (at 1220, as indicated by the directional line 1235).

In response to determining that the unevaluated context block is coded using a warped motion prediction mode (at 1230), the encoder, or a component thereof, for encoding, or the decoder, or a component thereof, for decoding, determines that the unevaluated context block is coded with reference to a current reference frame (at 1240), which includes determining whether the unevaluated context block is coded with reference to the current reference frame, wherein encoding the current block includes encoding the current block with reference to the current reference frame. The current reference frame may be indicated by a current reference frame index. In some implementations, the encoder, or a component thereof, for encoding, or the decoder, or a component thereof, for decoding, may determine that the unevaluated context block is coded with reference to a reference frame other than the current reference frame, the current unevaluated context block may be identified as an evaluated context block, and the encoder, or a component thereof, for encoding, or the decoder, or a component thereof, for decoding, may determine whether another unevaluated context block is available (at 1220, as indicated by the directional line 1245).

In response to determining that the unevaluated context block is coded with reference to the current reference frame (at 1240), the encoder, or a component thereof, for encoding, or the decoder, or a component thereof, for decoding, determines that warp motion model parameters from the unevaluated context block differ from the warp motion model parameters in the warp reference list (at 1250), which includes determining whether the warp motion model parameters from the unevaluated context block differ from the warp motion model parameters in the warp reference list. In some implementations, the encoder, or a component thereof, for encoding, or the decoder, or a component thereof, for decoding, may determine that the warp motion model parameters from the unevaluated context block match warp motion model parameters in the warp reference list, the current unevaluated context block may be identified as an evaluated context block, and the encoder, or a component thereof, for encoding, or the decoder, or a component thereof, for decoding, may determine whether another unevaluated context block is available (at 1220, as indicated by the directional line 1255).

In response to determining that warp motion model parameters from the unevaluated context block differ from the warp motion model parameters in the warp reference list (at 1250), the encoder, or a component thereof, for encoding, or the decoder, or a component thereof, for decoding, includes the warp motion model parameters from the unevaluated context block in the warp reference list (at 1260) at a sequentially minimal index location available in the warp reference list, such as the second index location, having the index value one (1), in the warp reference list.

After including the warp motion model parameters from the unevaluated context block in the warp reference list (at 1260) obtaining warp motion model parameters based on one or more context blocks 1200 may be repeated or iterated (as indicated by the directional line at 1265).

FIG. 13 is a block diagram of an example of a defined sequence 1300, such as for obtaining warp motion model parameters based on one or more context blocks (such as shown at 1200 in FIG. 12), in accordance with implementations of this disclosure.

FIG. 13 shows the current block 1310 as a 4×4 block. Other size blocks may be used. The defined sequence 1300 includes context blocks, which are previously reconstructed blocks spatially neighboring the current block 1310 in the current frame. As shown in FIG. 13, the context blocks are labeled with numbers indicating the respective position, or order, of the respective context block in the defined sequence 1300.

The defined sequence 1300 includes top context blocks from a row 1320 spatially adjacent to the current block 1310 above the current block 1310, which, in left to right order, includes a first context block (1) from the row 1320 spatially adjacent to the current block 1310 above the current block 1310, a second context block (2) from the row 1320 spatially adjacent to the current block 1310 above the current block 1310 subsequent, in left to right order, to the first context block (1), a third context block (4) from the row 1320 spatially adjacent to the current block 1310 above the current block 1310 subsequent, in left to right order, to the second context block (2), and a fourth context block (4) from the row 1320 spatially adjacent to the current block 1310 above the current block 1310 subsequent, in left to right order, to the third context block (3).

The defined sequence 1300 includes first left context blocks from a first column 1330 spatially adjacent to the current block 1310 to the left of the current block 1310, which, in top to bottom order, includes a fifth context block (5) from the first column 1330 spatially adjacent to the current block 1310 to the left of the current block 1310, a sixth context block (6) from the first column 1330 spatially adjacent to the current block 1310 to the left of the current block 1310 subsequent, in top to bottom order, to the fifth context block (5), a seventh context block (7) from the first column 1330 spatially adjacent to the current block 1310 to the left of the current block 1310 subsequent, in top to bottom order, to the sixth context block (6), and an eighth context block (8) from the first column 1330 spatially adjacent to the current block 1310 to the left of the current block 1310 subsequent, in top to bottom order, to the seventh context block (7).

The defined sequence 1300 includes, as a ninth context block (9), a top-right context block 1340 from a column spatially adjacent to the current block 1310 to the right of the current block 1310 and the row spatially adjacent to the current block 1310 above the current block 1310.

The defined sequence 1300 includes, as a tenth context block (10), a top-left context block 1350 from the column spatially adjacent to the current block 1310 to the left of the current block 1310 and the row spatially adjacent to the current block 1310 above the current block 1310.

The defined sequence 1300 includes second left context blocks from a second column 1360 spatially adjacent to the first column 1330 to the left of the first column 1330, which, in top to bottom order, includes an eleventh context block (11) from the second column 1360 spatially adjacent to the first column 1330 to the left of the first column 1330, a twelfth context block (12) from the second column 1360 spatially adjacent to the first column 1330 to the left of the first column 1330 subsequent, in top to bottom order, to the eleventh context block (11), a thirteenth context block (13) from the second column 1360 spatially adjacent to the first column 1330 to the left of the first column 1330 subsequent, in top to bottom order, to the twelfth context block (12), and a fourteenth context block (14) from the second column 1360 spatially adjacent to the first column 1330 to the left of the first column 1330 subsequent, in top to bottom order, to the thirteenth context block (13).

The defined sequence 1300 includes third left context blocks from a third column 1370 spatially adjacent to the second column 1360 to the left of the second column 1360, which, in top to bottom order, includes an fifteenth context block (15) from the third column 1370 spatially adjacent to the second column 1360 to the left of the second column 1360, a sixteenth context block (16) from the third column 1370 spatially adjacent to the second column 1360 to the left of the second column 1360 subsequent, in top to bottom order, to the fifteenth context block (15), a seventeenth context block (17) from the third column 1370 spatially adjacent to the second column 1360 to the left of the second column 1360 subsequent, in top to bottom order, to the sixteenth context block (16), and an eighteenth context block (18) from the third column 1370 spatially adjacent to the second column 1360 to the left of the second column 1360 subsequent, in top to bottom order, to the seventeenth context block (17).

FIG. 14 is a flowchart diagram of an example of obtaining warp motion model parameters based on a warp motion parameter bank 1400 in accordance with implementations of this disclosure. Obtaining warp motion model parameters based on the warp motion parameter bank 1400 may be implemented in an encoder, such as the encoder 400 shown in FIG. 4, or a decoder, such as the decoder 500 shown in FIG. 5.

The encoder, or a component thereof, for encoding, or the decoder, or a component thereof, for decoding, maintains, such as stores, a warp motion parameter bank, which may be a circular buffer, to store, record, or otherwise save, warp motion model parameters, such as zero or more sets of warp motion model parameters, previously used for coding one or more block of a current tile that includes the current block. The circular buffer for the current tile may be empty, such as in response to initialization or resetting, prior to coding the current tile, or in accordance with coding a sequentially first block of the current tile, or may include warp motion model parameters, such as zero or more sets of warp motion model parameters, previously used for coding a block of a current tile. Subsequent to coding a block, or a super-block, from the current tile, using a warp motion mode, the warp motion model parameters used for coding the block may be included, stored, recorded, or otherwise saved, in a location in the warp motion parameter bank corresponding to the location of the block in the current tile, a sequentially earliest, or lowest, available, empty, or unpopulated, location in the warp motion parameter bank, or in a sequentially last, or greatest, position, or location, in the warp motion parameter bank.

Including, storing, recording, or otherwise saving the warp motion model parameters used for coding the block in the sequentially last, or greatest, position, or location, in the warp motion parameter bank, wherein the sequentially last, or greatest, position, or location, in the warp motion parameter bank includes warp motion model parameters previously used for coding a block of the current tile, includes advancing the circular buffer, such that the warp motion model parameters included in the sequentially first location, or position, in the warp motion parameter bank are removed from the in the warp motion parameter bank, identifying the sequentially first location, or position, in the warp motion parameter bank as the sequentially last location, or position, in the warp motion parameter bank, identifying the sequentially second location, or position, in the warp motion parameter bank as the sequentially first location, or position, in the warp motion parameter bank, and including the warp motion model parameters used for coding the block in the sequentially last, or greatest, position, or location, in the warp motion parameter bank. Maintaining the warp motion parameter bank may include maintaining multiple distinct, or separate, warp motion parameter banks on a per-reference frame basis for the reference frames used for encoding the current tile, or a block thereof. The warp motion parameter bank may have a defined, or determined, size, or cardinality, such as sixteen (16). The defined, or determined, size, or cardinality, warp motion parameter bank may be signaled in the encoded bitstream by the encoder. The defined, or determined, size, or cardinality, warp motion parameter bank may be accessed, read, extracted, decoded, or otherwise obtained from the encoded bitstream by the decoder. In some implementations, the size, or cardinality, of the warp motion parameter bank may be defined prior to coding the current block, the current tile, the current frame, or the current video and signaling the size, or cardinality, of the warp motion parameter bank may be omitted, avoided, or excluded.

Obtaining warp motion model parameters based on the warp motion parameter bank 1400 includes determining that an index location is available in the warp reference list (at 1410), determining that unevaluated warp motion model parameters (unevaluated bank parameters) are available from the warp motion parameter bank (at 1420), determining that the unevaluated bank parameters differ from the warp motion model parameters in the warp reference list (at 1430), and including the unevaluated bank parameters in the warp reference list (at 1440).

The encoder, or a component thereof, for encoding, or the decoder, or a component thereof, for decoding, determines that an, or at least one, index location is available, unpopulated, or empty, in the warp reference list (at 1410), which includes determining whether an index location is available, unpopulated, or empty, in the warp reference list, wherein the index location is the sequentially, such as in increasing warp reference list index value order, minimal, or earliest, available, unpopulated, or empty, index location (sequentially minimal index location). In some implementations, the encoder, or a component thereof, or the decoder, or a component thereof may determine that an index location is unavailable in the warp reference list, such as wherein the index locations of the warp reference list include respective warp motion model parameters, and obtaining warp motion model parameters based on the warp motion parameter bank 1400 may be otherwise omitted, avoided, or excluded.

In response to determining that the index location is available, unpopulated, or empty, in the warp reference list (at 1410), the encoder, or a component thereof, for encoding, or the decoder, or a component thereof, for decoding, determines that unevaluated warp motion model parameters (unevaluated bank parameters) are available from the warp motion parameter bank (at 1420) for the current reference frame, wherein the current block is coded with reference to the current reference frame, which includes determining whether unevaluated warp motion model parameters (unevaluated bank parameters) are available from the warp motion parameter bank for the current reference frame. Determining that the unevaluated warp motion model parameters (unevaluated bank parameters) are available from the warp motion parameter bank (at 1420) for the current reference frame includes evaluating the warp motion model parameters, or warp motion parameter sets, from the warp motion parameter bank for the current reference frame in a defined sequence, or order, such as from the sequentially first location, or position, in the warp motion parameter bank to the sequentially last location, or position, in the warp motion parameter bank.

The unevaluated bank parameters are warp motion model parameters, or a warp motion parameter set, from the warp motion parameter bank for the current reference frame, other than warp motion model parameters, or a warp motion parameter set, from the warp motion parameter bank for the current reference frame previously evaluated in accordance with obtaining warp motion model parameters based on the warp motion parameter bank 1400 for the current block, that is the sequentially minimal, in the defined sequence, location, or position, in the warp motion parameter bank for the current reference frame. In some implementations, the encoder, or a component thereof, for encoding, or the decoder, or a component thereof, for decoding, may determine that unevaluated bank parameters are unavailable from the warp motion parameter bank for the current reference frame, such as wherein the warp motion model parameters, or a warp motion parameter set, from the warp motion parameter bank for the current reference frame were previously evaluated in accordance with obtaining warp motion model parameters based on the warp motion parameter bank 1400 for the current block, and obtaining warp motion model parameters based on the warp motion parameter bank 1400 may be otherwise omitted, avoided, or excluded.

In response to determining that the unevaluated bank parameters are available (at 1420), the encoder, or a component thereof, for encoding, or the decoder, or a component thereof, for decoding, determines that the unevaluated bank parameters differ from the warp motion model parameters in the warp reference list (at 1430), which includes determining whether the unevaluated bank parameters differ from the warp motion model parameters in the warp reference list. In some implementations, the encoder, or a component thereof, for encoding, or the decoder, or a component thereof, for decoding, may determine that the unevaluated bank parameters match warp motion model parameters in the warp reference list, the unevaluated bank parameters may be identified as evaluated, and the encoder, or a component thereof, for encoding, or the decoder, or a component thereof, for decoding, may determine whether other unevaluated bank parameters are available (at 1420, as indicated by the directional line 1435).

In response to determining that unevaluated bank parameters differ from the warp motion model parameters in the warp reference list (at 1430), the encoder, or a component thereof, for encoding, or the decoder, or a component thereof, for decoding, includes the unevaluated bank parameters in the warp reference list (at 1440) at the sequentially minimal index location available in the warp reference list, which may include identifying the unevaluated bank parameters as evaluated.

After including the unevaluated bank parameters in the warp reference list (at 1440) obtaining warp motion model parameters based on the warp motion parameter bank 1400 may be repeated or iterated (as indicated by the directional line at 1445).

FIG. 15 is a flowchart diagram of an example of obtaining warp motion model parameters based on global warp motion model parameters associated with the current reference frame 1500 in accordance with implementations of this disclosure. Obtaining warp motion model parameters based on the global warp motion model parameters associated with the current reference frame 1500 may be implemented in an encoder, such as the encoder 400 shown in FIG. 4, or a decoder, such as the decoder 500 shown in FIG. 5.

Obtaining warp motion model parameters based on the global warp motion model parameters associated with the current reference frame 1500 includes determining that an index location is available in the warp reference list (at 1510), identifying the global warp motion model parameters associated with the current reference frame (at 1520), determining that the global warp motion model parameters associated with the current reference frame differ from the warp motion model parameters in the warp reference list (at 1530), and including the global warp motion model parameters associated with the current reference frame in the warp reference list (at 1540).

The encoder, or a component thereof, for encoding, or the decoder, or a component thereof, for decoding, determines that an, or at least one, index location is available, unpopulated, or empty, in the warp reference list (at 1510), which includes determining whether an index location is available, unpopulated, or empty, in the warp reference list, wherein the index location is the sequentially, such as in increasing warp reference list index value order, minimal, or earliest, available, unpopulated, or empty, index location. In some implementations, the encoder, or a component thereof, or the decoder, or a component thereof may determine that an index location is unavailable in the warp reference list, such as wherein the index locations of the warp reference list include respective warp motion model parameters, and obtaining warp motion model parameters based on the global warp motion model parameters associated with the current reference frame 1500 may be otherwise omitted, avoided, or excluded.

In response to determining that the index location is available, unpopulated, or empty, in the warp reference list (at 1510), the encoder, or a component thereof, for encoding, or the decoder, or a component thereof, for decoding, identifies global warp motion model parameters associated with the current reference frame (at 1520), wherein the current block is coded with reference to the current reference frame.

In some implementations, the encoder, or a component thereof, for encoding, or the decoder, or a component thereof, for decoding, may determine (at 1520) that global warp motion model parameters associated with the current reference frame are unavailable and obtaining warp motion model parameters based on the global warp motion model parameters associated with the current reference frame 1500 may be otherwise omitted, avoided, or excluded.

In response to identifying the global warp motion model parameters associated with the current reference frame (at 1520), the encoder, or a component thereof, for encoding, or the decoder, or a component thereof, for decoding, determines that the global warp motion model parameters associated with the current reference frame differ from the warp motion model parameters in the warp reference list (at 1530), which includes determining whether the global warp motion model parameters associated with the current reference frame differ from the warp motion model parameters in the warp reference list. In some implementations, the encoder, or a component thereof, for encoding, or the decoder, or a component thereof, for decoding, may determine that the global warp motion model parameters associated with the current reference frame match warp motion model parameters in the warp reference list, and obtaining warp motion model parameters based on the global warp motion model parameters associated with the current reference frame 1500 may be otherwise omitted, avoided, or excluded.

In response to determining that global warp motion model parameters associated with the current reference frame differ from the warp motion model parameters in the warp reference list (at 1530), the encoder, or a component thereof, for encoding, or the decoder, or a component thereof, for decoding, includes the global warp motion model parameters associated with the current reference frame in the warp reference list (at 1540) at a sequentially minimal index location available in the warp reference list.

FIG. 16 is a flowchart diagram of an example of obtaining warp motion model parameters based on defined warp motion model parameters 1600 in accordance with implementations of this disclosure. Obtaining warp motion model parameters based on the defined warp motion model parameters 1600 may be implemented in an encoder, such as the encoder 400 shown in FIG. 4, or a decoder, such as the decoder 500 shown in FIG. 5.

Obtaining warp motion model parameters based on the defined warp motion model parameters 1600 includes determining that an index location is available in the warp reference list (at 1610), determining that unevaluated defined warp motion model parameters are available (at 1620), determining that the defined warp motion model parameters differ from the warp motion model parameters in the warp reference list (at 1630), and including the defined warp motion model parameters in the warp reference list (at 1640).

The encoder, or a component thereof, for encoding, or the decoder, or a component thereof, for decoding, determines that an, or at least one, index location is available, unpopulated, or empty, in the warp reference list (at 1610), which includes determining whether an index location is available, unpopulated, or empty, in the warp reference list, wherein the index location is the sequentially, such as in increasing warp reference list index value order, minimal, or earliest, available, unpopulated, or empty, index location. In some implementations, the encoder, or a component thereof, or the decoder, or a component thereof may determine that an index location is unavailable in the warp reference list, such as wherein the index locations of the warp reference list include respective warp motion model parameters, and obtaining warp motion model parameters based on the defined warp motion model parameters 1600 may be otherwise omitted, avoided, or excluded.

In response to determining that the index location is available, unpopulated, or empty, in the warp reference list (at 1610), the encoder, or a component thereof, for encoding, or the decoder, or a component thereof, for decoding, determines that unevaluated defined warp motion model parameters are available (at 1620), which includes determining whether unevaluated defined warp motion model parameters are available.

The encoder, or a component thereof, for encoding, or the decoder, or a component thereof, for decoding, includes, such as stores, defined warp motion model parameters, or one or more sets of defined warp motion model parameters, defined, and available to the encoder, the decoder, or both, prior to coding the current block, the current tile, the current frame, or the current video. In some implementations, the defined warp motion model parameters, or one or more of the sets of defined warp motion model parameters, may be defined, determined, generated, or otherwise obtained, by an offline training process. In some implementations, the defined warp motion model parameters may include zero motion defined warp motion model parameters, which may be expressed as (h₁₁=0, h₁₂=0, h₂₁=0, h₂₂=0, h₁₃=0, h₂₃=0).

The unevaluated defined warp motion model parameters are defined warp motion model parameters, or a defined warp motion parameter set, other than defined warp motion model parameters, or a defined warp motion parameter set, previously evaluated in accordance with obtaining warp motion model parameters based on defined warp motion model parameters 1600 for the current block. Determining that the unevaluated defined warp motion model parameters are available (at 1620) may include evaluating the defined warp motion model parameters, or defined warp motion parameter sets, in a defined sequence, or order.

In some implementations, the encoder, or a component thereof, for encoding, or the decoder, or a component thereof, for decoding, may determine that unevaluated defined warp motion model parameters are unavailable, such as wherein the defined warp motion model parameters warp motion model parameters were previously evaluated in accordance with obtaining warp motion model parameters based on defined warp motion model parameters 1600 for the current block, and obtaining warp motion model parameters based on defined warp motion model parameters 1600 may be otherwise omitted, avoided, or excluded.

In response to determining that the unevaluated defined warp motion model parameters are available (at 1620), the encoder, or a component thereof, for encoding, or the decoder, or a component thereof, for decoding, determines that the unevaluated defined warp motion model parameters differ from the warp motion model parameters in the warp reference list (at 1630), which includes determining whether the unevaluated defined warp motion model parameters differ from the warp motion model parameters in the warp reference list. In some implementations, the encoder, or a component thereof, for encoding, or the decoder, or a component thereof, for decoding, may determine that the unevaluated defined warp motion model parameters match warp motion model parameters in the warp reference list, and obtaining warp motion model parameters based on defined warp motion model parameters 1600 may be otherwise omitted, avoided, or excluded. In some implementations, the encoder, or a component thereof, for encoding, or the decoder, or a component thereof, for decoding, may determine that the unevaluated defined warp motion model parameters match warp motion model parameters in the warp reference list, the unevaluated defined warp motion model parameters may be identified as evaluated, and the encoder, or a component thereof, for encoding, or the decoder, or a component thereof, for decoding, may determine whether other unevaluated defined warp motion model parameters are available (at 1620, as indicated by the directional line 1635).

In response to determining that the unevaluated defined warp motion model parameters are available (at 1620), the encoder, or a component thereof, for encoding, or the decoder, or a component thereof, for decoding, includes the unevaluated defined warp motion model parameters in the warp reference list (at 1640) at a sequentially minimal index location available in the warp reference list, which may include identifying the unevaluated defined warp motion model parameters as evaluated.

After including the defined warp motion model parameters in the warp reference list (at 1640) obtaining warp motion model parameters based on the defined warp motion model parameters 1600 may be repeated or iterated (as indicated by the directional line at 1645).

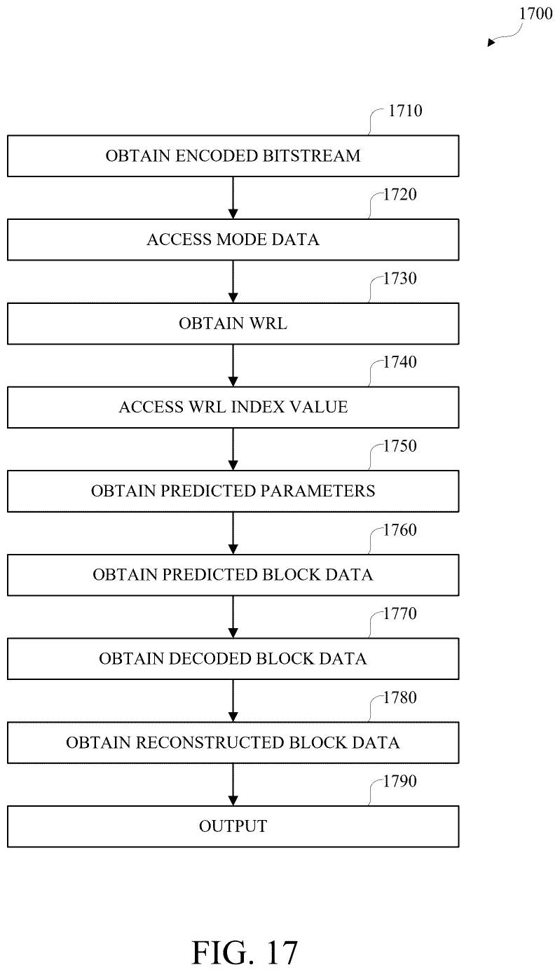

FIG. 17 is a flowchart diagram of an example of decoding using warped motion compensation 1700 in accordance with implementations of this disclosure. Decoding using warped motion compensation 1700 may be implemented in a decoder, such as the decoder 500 shown in FIG. 5.

Decoding using warped motion compensation 1700 includes decoding an encoded bitstream, such as the compressed bitstream 502 shown in FIG. 5, or one or more portions thereof, to generate a reconstructed video, or a portion thereof, such as the output video stream 504 shown in FIG. 5.

The decoder may maintain, such as store in local memory, such as in a decoded frame buffer (or reference frame buffer, or reconstructed frame buffer), one or more reconstructed frames, which may be used reference frames for inter prediction, which is similar to the reconstructed frame buffer maintained by the encoder as described with reference to FIG. 7, except as is described herein or as is otherwise clear from context.

Decoding using warped motion compensation 1700 includes obtaining the encoded bitstream (at 1710), accessing mode data (at 1720), obtaining a warp reference list (at 1730), accessing a warp reference list index value (at 1740), obtaining predicted warp motion model parameters (at 1750), obtaining predicted block data (at 1760), obtaining decoded block data (at 1770), obtaining reconstructed block data (at 1780), and outputting the reconstructed block (at 1790).

The encoded bitstream is obtained (at 1710). Obtaining the encoded bitstream includes identifying a current frame to decode from the encoded bitstream to generate a current reconstructed frame, which includes identifying a current block from the current frame to decode from the encoded bitstream to generate a current reconstructed block to include in the current reconstructed frame. For example, the decoder, or a component thereof, such as an intra/inter prediction unit of the decoder, such as the entropy decoding unit 510 shown in FIG. 5, may obtain the input video stream. The current frame may be obtained (at 1710) after decoding one or more other frames, such as a frame sequentially preceding the current frame, and generating, or otherwise obtaining, a corresponding reconstructed frame (or frames), or one or more portions thereof, for use as a reference frame (or frames) for decoding the current frame. Although not shown separately in FIG. 17, decoding using warped motion compensation 1700 may include decoding, reconstructing, or both, one or more portions of the current frame prior to decoding, reconstructing, or both, the current block.

Although not shown separately in FIG. 17, in some implementations, prior to decoding the current frame, or a block thereof, the decoder may access, read, extract, decode, such as entropy decode, or otherwise obtain, from the encoded bitstream, a frame level flag, bit, symbol, data element, or other syntax element, indicating whether the warp motion vector prediction mode is enabled, available, or usable, for the current frame or is disabled, unavailable, or unusable for the current frame.

The mode data for the current block is accessed from the encoded bitstream (at 1720).

Accessing, reading, extracting, decoding, such as entropy decoding, or otherwise obtaining, from the encoded bitstream, the mode data for the current block includes accessing prediction mode data for the current block from the encoded bitstream.

The prediction mode data for the current block indicates whether the prediction mode for the current block is an intra prediction mode or an inter prediction mode. For decoding using warped motion compensation 1700, the prediction mode data for the current block indicates that the prediction mode for the current block is an inter prediction mode. The prediction mode data for the current block indicates whether the prediction mode for the current block is unitary, single, or non-compound prediction mode. For decoding using warped motion compensation 1700, the prediction mode data for the current block indicates that the prediction mode for the current block is a unitary, single, or non-compound inter prediction mode.

The prediction mode data for the current block indicates whether the prediction mode for the current block is the warp motion vector prediction mode or a prediction mode other than the warp motion vector prediction mode.

Accessing, reading, extracting, decoding, such as entropy decoding, or otherwise obtaining, from the encoded bitstream, the prediction mode data for the current block, such as wherein the prediction mode data for the current block indicates that the prediction mode for the current block is a non-compound inter prediction mode, includes accessing, reading, extracting, decoding, such as entropy decoding, or otherwise obtaining, from the encoded bitstream, a bit, flag, symbol, data element, or other syntax element, (is_warpmv) indicating whether the warp motion vector prediction mode (WARPMV) is the prediction mode for the current block.

Accessing, reading, extracting, decoding, such as entropy decoding, or otherwise obtaining, from the encoded bitstream, the mode data for the current block includes accessing motion mode data for the current block from the encoded bitstream.

Accessing, reading, extracting, decoding, such as entropy decoding, or otherwise obtaining, from the encoded bitstream, the motion mode data for the current block includes accessing, reading, extracting, decoding, such as entropy decoding, or otherwise obtaining, from the encoded bitstream, at least one bit, flag, symbol, data element, or other syntax element, indicating the motion mode for the current block.

In some implementations, the prediction mode data for the current block indicates that the prediction mode for the current block is the warp motion vector prediction mode and the motion mode data for the current block indicates whether the motion mode for the current block is the causal warp motion mode (WARP_CAUSAL) or the differential warp motion mode (WARP_DELTA).

In some implementations, the prediction mode data for the current block indicates that the prediction mode for the current block is other than the warp motion vector prediction mode and the motion mode data for the current block indicates whether the motion mode for the current block is the causal warp motion mode (WARP_CAUSAL), the differential warp motion mode (WARP_DELTA), the extended warp motion mode (WARP_EXTEND), or a non-warp motion mode, such as a translational motion mode.

Although not shown separately in FIG. 17, in some implementations, the prediction mode data for the current block indicates that the prediction mode for the current block is other than the warp motion vector prediction mode, and decoding using warped motion compensation 1700 includes obtaining, determining, or generating a translational dynamic reference list (DRL). Obtaining the translational dynamic reference list is like generating the translational dynamic reference list as described with respect to FIG. 7 (at 720), except as is described herein or as is otherwise clear from context.

The warp reference list (WRL) is obtained, determined, generated, or derived (at 1730). Obtaining the warp reference list (at 1730) is like obtaining a warp reference list as shown (at 720) in FIG. 7, except as is described herein or as is otherwise clear from context. An example of obtaining the warp reference list is shown in FIG. 8.

Although not shown separately in FIG. 17, in some implementations, the prediction mode data for the current block indicates that the prediction mode for the current block is other than the warp motion vector prediction mode and the motion mode data for the current block indicates that the motion mode for the current block is the differential warp motion mode (WARP_DELTA), and decoding using warped motion compensation 1700 includes accessing, reading, extracting, decoding, such as entropy decoding, or otherwise obtaining, from the encoded bitstream, a translational dynamic reference list index value, or reference motion vector index value, (ref_drl_idx or ref_mv_idx) for a translational dynamic reference list.

The warp reference list index value is accessed (at 1740). Accessing the warp reference list index value (WRL INDEX VALUE or warp_ref_idx) includes decoding, such as entropy decoding, reading, extracting, obtaining, or otherwise accessing, the warp reference list index value for the current block from the encoded bitstream. The warp reference list index value corresponds to, or indicates, predicted warp motion model parameters from the warp reference list.

The predicted warp motion model parameters are obtained (at 1750). Obtaining the predicted warp motion model parameters, which may be optimal, or selected, predicted warp motion model parameters, includes obtaining the predicted warp motion model parameters from the warp reference list in accordance with, or as indicated by, the warp reference list index value.

Predicted block data for the current block is obtained (at 1760). The predicted block data is obtained by decoding the current block using the predicted warp motion model parameters.

Obtaining the predicted block data for the current block includes obtaining a motion vector, such as a translational motion vector or a warp motion vector, for decoding the current block. Obtaining the predicted block data for the current block includes obtaining the predicted block data for the current block in accordance with the motion vector.

Obtaining the motion vector for the current block includes obtaining a motion vector prediction for the current block.

In some implementations, such as wherein the prediction mode for the current block is the warp motion vector prediction mode, the motion vector prediction for the current block is obtained, such as derived, from the warp reference list (WRL), such as in accordance with the predicted warp motion model parameters obtained from the warp reference list in accordance with, or as indicated by, the warp reference list index value.

In some implementations, such as wherein the prediction mode for the current block is other than the warp motion vector prediction mode, the decoder obtains, such as derives, a translational motion vector prediction for the current block from the translational dynamic reference list (DRL), the decoder obtains, such as derives, non-translational motion parameters for the current block from the warp reference list (WRL), such as in accordance with the predicted warp motion model parameters obtained from the warp reference list in accordance with, or as indicated by, the warp reference list index value, and the decoder obtains the warp motion vector for the current block as a combination of the translational motion vector and the non-translational motion parameters.

In some implementations, such as wherein, or on a condition that, the prediction mode for the current block is other than the warp motion vector prediction mode, the motion mode for the current block is the differential warp motion mode (WARP_DELTA), and the frame level flag, bit, symbol, data element, or other syntax element, indicating whether the warp motion vector prediction mode is enabled, available, or usable, for the current frame indicates that the warp motion vector prediction mode is enabled, available, or usable, for the current frame, obtaining the predicted block data (at 1760) includes obtaining current, or optimal, warp motion model parameters for the current block, which may differ from the predicted warp motion model parameters for the current block.

In some implementations, such as wherein the prediction mode for the current block is other than the warp motion vector prediction mode, the motion mode for the current block is the differential warp motion mode (WARP_DELTA), and the frame level flag, bit, symbol, data element, or other syntax element, indicating whether the warp motion vector prediction mode is enabled, available, or usable, for the current frame indicates that the warp motion vector prediction mode is enabled, available, or usable, for the current frame, obtaining the predicted block data (at 1760) includes accessing, reading, decoding, such as entropy decoding, extracting, or otherwise obtaining, from the encoded bitstream, differential warp motion model parameters for the current block and obtaining the current, or optimal, warp motion model parameters for the current block using the differential warp motion model parameters for the current block.

Obtaining the current, or optimal, warp motion model parameters (h) for the current block using the differential warp motion model parameters for the current block includes combining, or adding (a sum), the predicted warp motion model parameters (h′) and the differential warp motion model parameters (Δh), wherein obtaining a current, or optimal, warp model parameter (hₘₙ) includes combining, or adding, the corresponding predicted warp model parameter (h′ₘₙ) and the corresponding differential warp motion model parameter (Δhₘₙ), wherein 1≤m, n≤2 for a six-parameter affine warp motion model or 1≤m≤2, n=1 for a four-parameter similarity warp motion model, which may be expressed as the following:

$${h}_{m n} = Δ {h}_{m n} + {( {h}^{′} )}_{m n} . \qquad [ Equation 8 ]$$

In some implementations, such as wherein the prediction mode for the current block is the warp motion vector prediction mode, the motion mode for the current block is the other than the differential warp motion mode (WARP_DELTA), the warp reference list index value (WRL INDEX VALUE or warp_ref_idx) for the current block is other than one (warp_ref_idx!=1), or the frame level flag, bit, symbol, data element, or other syntax element, indicating whether the warp motion vector prediction mode is enabled, available, or usable, for the current frame indicates that the warp motion vector prediction mode is disabled, unavailable, or unusable, for the current frame, obtaining the predicted block data (at 1760) omits, skips, avoids, or excludes obtaining the differential warp motion model parameters, wherein the differential warp motion model parameters are omitted, absent, or excluded, from the encoded bitstream, and the predicted warp motion model parameters for the current block are used as the warp motion model parameters for the current block.

In some implementations, such as wherein the prediction mode for the current block is the warp motion vector prediction mode, obtaining the predicted block data includes decoding, such as entropy decoding, reading, extracting, obtaining, or otherwise accessing, from the encoded bitstream, a bit, flag, symbol, data element, or other syntax element, (warpmv_with_mvd_flag) indicating whether a motion vector difference value is signaled in the encoded bitstream.

In some implementations, such as wherein the prediction mode for the current block is the warp motion vector prediction mode and the warp reference list index value is greater than or equal to a defined threshold, such as two, (warp_ref_idx>=2), the decoder omits, excludes, skips, or avoids accessing, from the encoded bitstream, the bit, flag, symbol, data element, or other syntax element, (warpmv_with_mvd_flag) indicating whether the motion vector difference value is signaled in the encoded bitstream (warpmv_with_mvd_flag=0).

In some implementations, such as wherein the bit, flag, symbol, data element, or other syntax element that indicates whether the motion vector difference value is signaled in the encoded bitstream, indicates that motion vector difference value is signaled in the encoded bitstream (warpmv_with_mvd_flag=1), obtaining the predicted block data includes decoding, such as entropy decoding, reading, extracting, obtaining, or otherwise accessing, from the encoded bitstream, the motion vector difference value (MVD), and obtaining the warp motion vector for the current block includes obtaining, as the warp motion vector for the current block, a combination, such as a sum, of the motion vector difference value and the motion vector prediction for the current block.

In some implementations, such as wherein the bit, flag, symbol, data element, or other syntax element that indicates whether the motion vector difference value is signaled in the encoded bitstream, is absent from the encoded bitstream or indicates that motion vector difference value is absent from the encoded bitstream (warpmv_with_mvd_flag=0), obtaining the predicted block data omits, excludes, skips, or avoids accessing, from the encoded bitstream, the motion vector difference value (MVD=0) and obtaining the motion vector for the current block includes obtaining, as the motion vector for the current block, the motion vector prediction for the current block.

Obtaining the predicted block data includes obtaining, or generating, the predicted block data using the motion vector and a corresponding reference frame.

The decoded block data (residual block) is obtained (at 1770) by decoding, reading, extracting, or otherwise accessing, encoded block data from the encoded bitstream and decoding, such as entropy decoding, the encoded block data.

The reconstructed block data (reconstructed block) is obtained (at 1780) by combining, such as by adding, the predicted block data and the decoded block data. Obtaining the reconstructed block data may include aspects not expressly shown in FIG. 17 for simplicity, such as filtering, such as the filtering shown (at 560) in FIG. 5.

The reconstructed block is output (at 1790), such as by including the reconstructed block data in reconstructed frame data and including the reconstructed frame data in the output.

In the warp motion modes described above, not all parameters (models) are signaled. For example, the differential warp motion mode (WARP_DELTA) may use a six-parameter model where only the delta (difference) of four parameters is signaled. According to the teachings herein, all parameters may be signaled—in this example, the delta of six parameters. In some implementations, the increased number of bits for signaling the parameters are offset by an improved predictor for a block, which reduces the number of bits needed to transmit a residual for the block and/or reduces distortion in the reconstructed block.

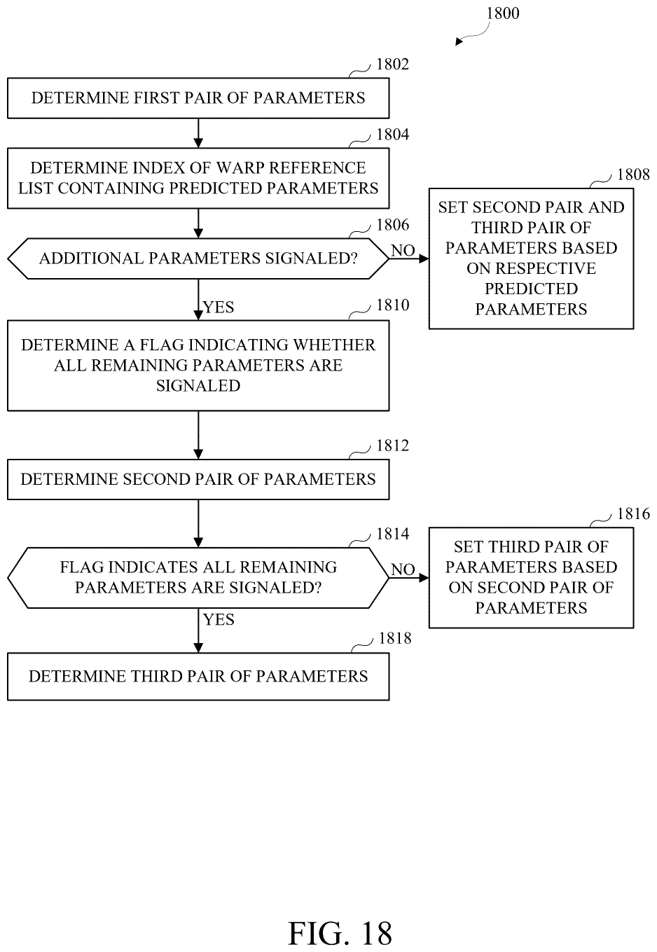

FIG. 18 is a flowchart diagram of a technique 1800 for determining warp motion model parameters based on a number (or cardinality) of signaled warp motion model parameters for a warp mode, such as the differential warp motion mode (WARP_DELTA). For example, a warp motion model may use six parameters, all or a portion of which (e.g., two, four, six) may be signaled. The warp motion model may be the affine warp motion model described above in relation to Equation 1 and Equation 2, or the similarity warp motion model described above in relation to Equation 3 and Equation 4. The parameters of the warp motion model may include a first pair of parameters (h₁₃, h₂₃) containing a first parameter (h 13) and a second parameter (h₂₃), a second pair of parameters (h₁₁, h₂₂) containing a third parameter (h₁₁) and a fourth parameter (h₂₂), and a third pair of parameters (h₁₂, h₂₁) containing a fifth parameter (h 12) and a sixth parameter (h₂₁).

The technique 1800 may be performed at an encoder, such as the encoder 400 shown in FIG. 4, or at a decoder, such as the decoder 500 shown in FIG. 5. The technique 1800 may be performed in whole or in part in a prediction stage of an encoder or decoder.

At 1802, the first pair of parameters (e.g., the first parameter and the second parameter) is determined. The first pair of parameters may be signaled in a bitstream. The first pair of parameters may be determined using a motion vector residual for the differential warp motion mode (WARP_DELTA). For example, the first parameter for the differential warp motion mode may be determined using a first motion vector residual and a first predicted motion vector and the second parameter for the differential warp motion mode may be determined using a second motion vector residual and a second predicted motion vector. The first parameter and the second parameter may represent a translational motion model of the six-parameter warp motion model. In some implementations, the first parameter and the second parameter may be encoded or decoded using conventional MVD coding methods.

At 1804, an index value (warp_ref_idx) of a warp reference list is determined. The warp reference list may contain predicted parameters for parameters, such as the second pair of parameters and the third pair of parameters (e.g., the third parameter through the sixth parameter). The warp reference list may be generated for the current block. The warp reference list is a list, or array, of warp motion parameter sets obtained, generated, or otherwise accessed, from the context blocks for the current block.

The warp reference list may have a defined, or determined, size, or cardinality, (N), which may be a positive integer value, such as four (N=4). A respective element, record, or row, of the warp reference list includes predicted parameters for a corresponding warp motion model. The predicted parameters at a location, or position, in the warp reference list may be indicated, identified, or identifiable, by a warp reference list index value (warp_ref_idx). For example, the cardinality of the warp reference list may be four (N=4) and the warp reference list may include first warp motion model parameters at warp reference list index value zero (0), second warp motion model parameters at warp reference list index value one (1), third warp motion model parameters at warp reference list index value two (2), and fourth warp motion model parameters at warp reference list index value three (3). An example of determining a warp reference list is shown in FIG. 8.

At 1806, the technique 1800 determines whether additional parameters (e.g., the second pair of parameters, the third pair of parameters, or all of the third parameter through the sixth parameter) are signaled. At an encoder, determining whether additional parameters are signaled may include performing an analysis (e.g., calculation, comparison) to determine an optimal number of parameters to signal. This analysis may be based on quality, efficiency, size, similarity between parameters, accuracy of predicted parameters, or the like. The technique 1800 may determine that only the first pair of parameters is signaled (e.g., at 1802), or that additional parameters (e.g., the second pair of parameters, the third pair of parameters, the third parameter through the sixth parameter) are signaled. The encoder may indicate that additional parameters are signaled by transmitting a particular value for warp_ref_idx, such as 1.

At a decoder, determining whether additional parameters are signaled may be based on the warp reference list index value (warp_ref_idx). For example, if the warp reference list index value (warp_ref_idx) is equal to a specified value, the decoder may decode additional parameters from the bitstream, and if the warp reference list index value (warp_ref_idx) is not equal to the specified value, the decoder may determine values for the additional parameters, for example, using the predicted parameters at 1808. In some implementations, if the warp reference list index value is equal to one (e.g., warp_ref_idx==1), then the decoder may decode the additional parameters.

At 1808, the second pair of parameters and the third pair of parameters are set based on respective predicted parameters. For example, a value of each of the additional parameters (e.g., the third parameter through the sixth parameter) may be set equal to a value of a respective predicted parameter. Each of the four parameters may be represented by actual_param[n], and each of the four predicted parameters may be represented by predicted_param[n], where “n” is a value from 2 to 5 corresponding to each of the four parameters. For example, setting the second pair of parameters and the third pair of parameters based on respective predicted parameters may include setting, for values of n between 2 and 5, inclusive, actual_param[n] equal to predicted_param[n] from the WRL (e.g., based on the value of warp_ref_idx).

If instead additional parameters are signaled (YES at 1806), it may be determined whether some or all remaining parameters of the warp motion model are signaled. In this six-parameter example, the additional parameters comprising at least the second pair of parameters are signaled.

At 1810, a flag (six_parameter_model_flag) is determined that indicates whether all remaining parameters (e.g., whether only the second pair of parameters or both the second pair of parameters and the third pair of parameters) are signaled is determined. At an encoder, determining the flag may include encoding a value of the flag into the bitstream. At a decoder, determining the flag may include decoding a value of the flag from the bitstream. The flag may be a bit, symbol, data element, or other syntax element to indicate how many (e.g., two or four) additional parameters are signaled. For example, the flag may be set as 0 (e.g., false or not all remaining parameters) or 1 (e.g., true or all remaining parameters).

In some embodiments, the flag is not signaled in the bitstream. The flag may be derived or inferred from the warp reference list index value (warp_ref_idx) or another value related to the encoded block. For example, if the warp reference list index value is equal to zero (e.g., warp_ref_idx==0) then the flag may be determined as 1, and if the step size index value is not equal to zero, the flag may be determined as 0.

At 1812, the second pair of parameters is determined. Determining the second pair of parameters may include determining a delta (e.g., residual) for each parameter. The delta may be a difference between the actual parameter and the predicted parameter. At an encoder, the delta may be quantized using a step size, and an index value for each parameter may be signaled. The step size may be set between the encoder and the decoder. The step size may be a value that, when multiplied by the index value for a parameter, produces the delta for the parameter. In an example, the step size may be a left-shifted value (obtained by left shifting), for example, the step size may be equal to (1<<10).

To determine the second pair of parameters at a decoder, the actual parameter may be equal to the sum of the predicted parameter and the delta for that parameter. For example, for values of n of 2 and 3 (e.g., the third parameter and the fourth parameter), actual_param[n] may be set equal to the sum of predicted_param[n] and the delta, where the delta is the index value multiplied by the step size. Another formula for determining the second pair of parameters may be used.

In some embodiments, multiple values of the step size may be allowed, and the step size may be signaled in the bitstream. Signaling the step size may be performed at the frame level, the block level, or the super-block level. For example, a step size index value (step_size_index) may be signaled in the bitstream. The step size index value may indicate the step size from two or more possible step sizes. For example, if the step size index value (warp motion model parameters quantization step size mode) is equal to zero (e.g., step_size_index=0) then the step size may be equal to a result of left shifting one by a first defined value, such as eleven (11), (1<<11), and if the step size index value is not equal to zero, the step size may be equal to a result of left shifting one (a left shift of one) by a second defined value, such as ten (10), (1<<10). That is, although not shown in FIG. 18 (because a single constant step size is assumed), a step size index value may be used to determine the step size for determining the second pair of parameters (and the third set of parameters when those are signaled).

At 1814, the technique 1800 determines whether the flag indicates that the remaining (e.g., the third pair of) parameters is signaled in the bitstream. If no, the technique 1800 proceeds to 1816.

At 1816, the third pair of parameters (i.e., the fifth parameter and the sixth parameter) is determined based on the second pair of parameters (i.e., the third parameter and the fourth parameter). For example, the fifth parameter and the sixth parameter may each be set equal to the third parameter, the fourth parameter, the third parameter multiplied by −1, or the fourth parameter multiplied by −1. The fifth parameter and the sixth parameter may be set to different values. In some embodiments, the fifth parameter is set equal to the fourth parameter multiplied by −1 (e.g., actual_param[4]=−actual_param[3]) and the sixth parameter is set equal to the third parameter (e.g., actual_param[5]=actual_param[2]).

If instead the remaining parameters are signaled (YES at 1814), the third pair of parameters is determined at 1818. Determining the third pair of parameters may be similar to determining the second pair of parameters. Determining the third pair of parameters may include determining a delta (e.g., residual) for each parameter. The delta may be a difference between the actual parameter and the predicted parameter. The delta may be quantized using a step size, and an index value for each parameter may be signaled by an encoder. The step size may be the same step size used to determine the second pair of parameters. The step size may be set between the encoder and the decoder. The step size may be a value that, when multiplied by the index value for a parameter, produces the delta for the parameter. In an example, the step size may be a left-shifted value, for example, the step size may be equal to (1<<10). The step size may correspond to a signaled step size index.

To determine the third pair of parameters at a decoder, the actual parameter may be equal to the sum of the predicted parameter and the delta for that parameter. For example, for values of n of 4 and 5 (e.g., the fifth parameter and the sixth parameter), actual_param[n] may be set equal to the sum of predicted_param[n] from the WRL and the delta, where the delta is the index value multiplied by the step size. Another formula for determining the third pair of parameters may be used.

The sequence of operations in FIG. 18 may differ from that shown. The second pair of parameters may be determined regardless of the value of the flag determined at 1810. That is, the technique determines at 1806 whether additional parameters are signaled, and if so, at least the second pair of parameters will be signaled regardless of whether the third pair of parameters is signaled. Thus, if the technique 1800 determines, at 1806, that the additional parameters are signaled in the bitstream, the second pair of parameters may be determined before or after determining whether the flag indicates that all remaining (e.g., including the third pair of) parameters are signaled at 1814. Similarly, the flag may be determined after determining the second pair of parameters instead of before determining the second pair of parameters.

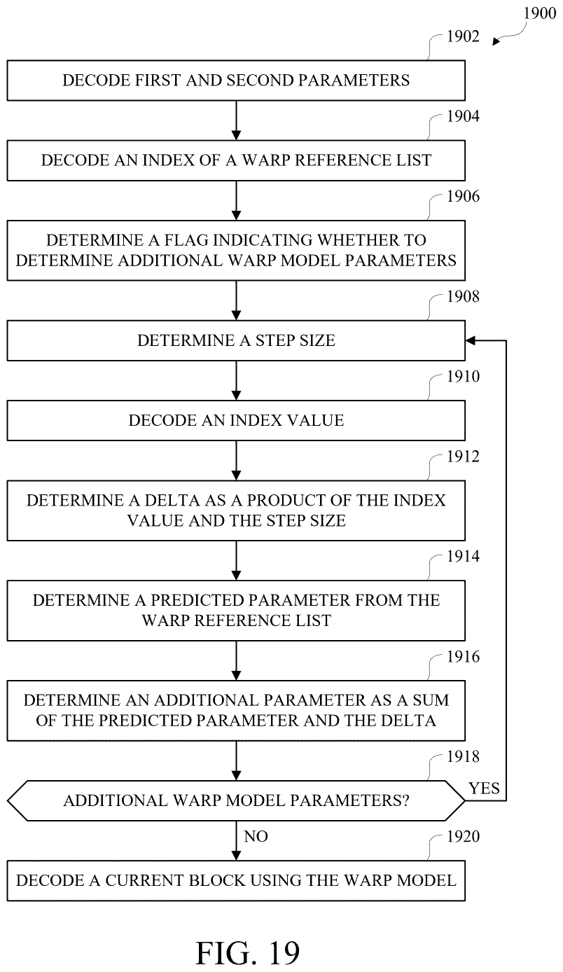

Once all parameters are determined according to FIG. 18, the resulting six-parameter warp motion model can be used to encode or decode the current block using inter prediction. For example, the model can be used to determine a prediction block for the current block. Then, at an encoder, a residual for the current block can be determined as a difference between the prediction block and the current block and encoded into a compressed bitstream. At a decoder, the residual can be decoded from the compressed bitstream and added to the prediction block. A possible technique for decoding is shown in FIG. 19.

FIG. 19 is a flowchart diagram of a technique 1900 of decoding using warped motion compensation based on the amount of signaled warp motion model parameters. The technique 1900 may be implemented in a decoder, such as the decoder 500 shown in FIG. 5.

At 1902, a first parameter and a second parameter of a warp model are decoded. The warp model may be a six-parameter warp motion model. A value of the first parameter and the second parameter may be decoded from a bitstream. The first parameter and the second parameter may correspond to the first pair of parameters. The first parameter may be determined using a first motion vector residual (decoded from the bitstream) and a first predicted motion vector and the second parameter may be determined using a second motion vector residual (decoded from the bitstream) and a second predicted motion vector. The first parameter and the second parameter may represent a translational motion model of the six-parameter warp motion model.

At 1904, an index of a warp reference list is decoded. The warp reference list may contain predicted parameters for the second pair of parameters and optionally the third pair of parameters (e.g., the third parameter through the sixth parameter). The warp reference list may be generated for the current block as described previously. The warp reference list is a list, or array, of warp motion parameter sets obtained, generated, or otherwise accessed, from the context blocks for the current block.

At 1906, a flag (six_parameter_model_flag) is determined that indicates whether to determine two or four additional parameters (e.g., the third parameter through the sixth parameter) of the warp model from the bitstream (e.g., the parameters are signaled in the bitstream). The flag may be a bit, symbol, data element, or other syntax element indicating to determine four additional parameters from the bitstream. For example, the flag may be determined by decoding a value of the flag from the bitstream. Alternatively, the flag may be determined based on the warp reference list index value (warp_ref_idx). For example, if the warp reference list index value is a specified value (e.g., equal to zero, that is, warp_ref_idx==0) then the flag may indicate to determine the four additional parameters. Although not shown in FIG. 19, if additional parameters have not been signaled in the bitstream, the four additional parameters may correspond to the values of the predicted parameters corresponding to the index of the WL, which are then used in the warp model to decoder the current block at 1920.

At 1908, a step size is determined. The step size may be used to calculate a delta for each of the four additional parameters. The step size may be the same four each of the four additional parameters, may be different for each of the four additional parameters, or may be a first same step size for the third parameter and the fourth parameter (e.g., the second pair of parameters) and a second same step size for the fifth parameter and the sixth parameter (e.g., the third pair of parameters). The step size may be a constant value known to each of an encoder and the decoder or decoded from the bitstream. The step size may be signaled in the bitstream at the frame level, the block level, or the super-block level. In an example, a step size index value (step_size_index) is signaled in the bitstream. The step size index value may indicate the step size from two or more possible step sizes. For example, if the step size index value is equal to zero (e.g., step_size_index==0) then the step size may be equal to (1<<11), and if the step size index value is not equal to zero, the step size may be equal to (1<<10). The step size index values and corresponding step sizes may be stored as a predefined table at each of an encoder and the decoder, or they may be signaled in a (e.g., frame or sequence) header.

The steps 1908 through 1916 may be performed for each of the four additional parameters. Step 1908 may not be repeated for additional parameters sharing a step size. At 1910, an index value is decoded for a current additional parameter. The index value may be used to calculate the delta for the current additional parameter. The index value may be decoded from the bitstream. The index value may be a value, for example, a value between 0 and 7. The index value may be shared by pairs of parameters. Hence step 1910 may not be performed for each additional parameter.

At 1912, a delta (e.g., residual) for the current additional parameter is determined as a product of the index value for the current parameter and the step size. The delta may be a difference between the actual parameter and the predicted parameter. Step 1912 may not be repeated if the same step size and index value are used for more than one additional parameter.

At 1914, a predicted parameter for the current additional parameter is determined from the warp reference list. The predicted parameter may be an approximation of the current additional parameter. The predicted parameter may be represented by predicted_param[n], where “n” is a value from 2 to 5 corresponding to each of the four additional parameters.

At 1916, an additional parameter of the two or four additional parameters (e.g., the current additional parameter) is determined as a sum of the predicted parameter for the current additional parameter and the delta for the current additional parameter. The current additional parameter may be represented by actual_param[n]. For example, for values of n of 2 to 5 (e.g., the third parameter, the fourth parameter, the fifth parameter, and the sixth parameter), actual_param[n] may be set equal to the sum of predicted_param[n] and the delta. Another formula for determining the current additional parameter may be used. A current additional parameter determined in this way may be more accurate than a predicted parameter from the warp reference list.

At 1918, the technique 1900 determines whether there are additional parameters to decode. If there are additional parameters to decode, the technique 1900 returns to 1908 as described above. When four additional parameters are decoded, the steps are repeated four times, and then the technique 1900 proceeds to 1920. Otherwise, the steps may be repeated two times to determine two additional parameters, with the final parameters set based on the two additional parameters. The steps may be performed for each additional parameter concurrently or subsequently.

At 1920, the current block is decoded using the warp model. Decoding the current block using the warp model may include using inter prediction and the six-parameter warp motion model to reconstruct the current block as described previously.

As can be seen, the technique 1900 as shown may be modified to perform at least a portion of the technique 1800 described with respect to FIG. 18. That is, the technique 1900 may decode all six parameters of the six-parameter warp motion model from the bitstream, may decode four parameters (e.g., the first pair of parameters and the second pair of parameters) of the six-parameter warp motion model from the bitstream, or may decode only two parameters (e.g., the first pair of parameters) of the six-parameter warp motion model from the bitstream.

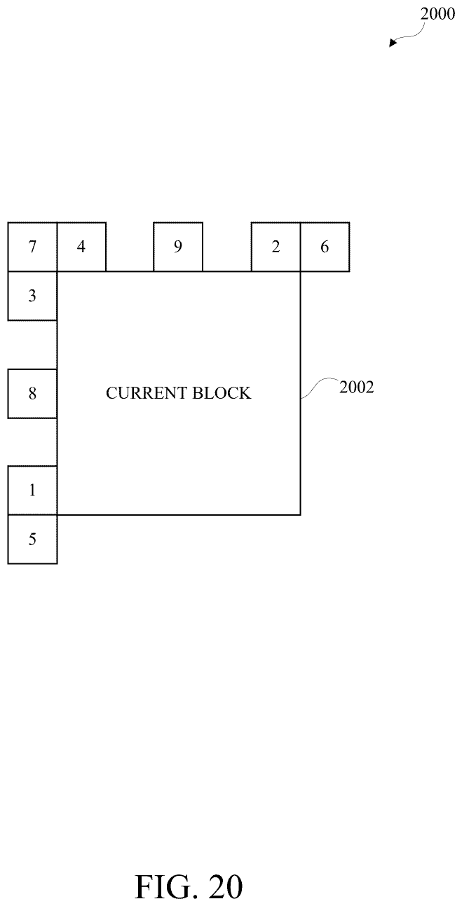

FIG. 20 is a block diagram of an example of a defined sequence 2000, such as for determining whether to allow a current block 2002 to use six-parameter signaling, that is, when the first parameter through the sixth parameter are encoded into or decoded from the bitstream, as described in FIGS. 18 and 19, instead of two or four parameters. Six-parameter signaling may not be allowed for all blocks. The defined sequence 2000 depicts nine locations, numbered (1) through (9), surrounding the current block 2002.

The defined sequence 2000 may represent a list of neighboring blocks. Multiple locations from the nine locations may be part of the same neighboring block. For example, a first location (1) and an eighth location (8) may be within the same neighboring block. Alternatively, each of the nine locations may be part of a different neighboring block, and one or more of the nine locations may be a part of multiple neighboring blocks.

Whether the current block 2002 allows six-parameter signaling may be based on the nine locations. For example, if none of the blocks located at the nine locations use warped motion compensation, then six-parameter signaling may be disabled for the current block 2002. In another example, six-parameter signaling may be disabled for the current block 2002 only if none of the blocks located at the nine locations use six-parameter signaling. In another example, six-parameter signaling may be disabled for the current block 2002 only if less than a specified number of the blocks located at the nine locations use warped motion compensation.

The defined sequence 2000 may represent an order for checking the list of neighboring blocks. For example, the defined sequence 2000 may check the nine locations in ascending order starting with the first location (1) and ending with the ninth location (9). In some embodiments, six-parameter signaling is disabled for the current block 2002 only if none of the blocks located at the nine locations use warped motion compensation. Therefore, the defined sequence 2000 may end after determining that a neighboring block does use warped motion compensation. The order of the defined sequence 2000 may allow for a neighboring block that does use warped motion compensation to be located more efficiently, but the order of the defined sequence 2000 is not required.

If six-parameter signaling is disabled for a block, the flag (e.g., six_parameter_model_flag) may be omitted from the bitstream and/or the decoder may not infer its value.

As used herein, the terms “optimal”, “optimized”, “optimization”, or other forms thereof, are relative to a respective context and are not indicative of absolute theoretic optimization unless expressly specified herein.

As used herein, the term “set” indicates a distinguishable collection or grouping of zero or more distinct elements or members that may be represented as a one-dimensional array or vector, except as expressly described herein or otherwise clear from context.

The words “example” or “embodiment” or “aspect” or “implementation” are used herein to mean serving as an example, instance, or illustration. Any aspect or design described herein as such are not necessarily to be construed as preferred or advantageous over other aspects or designs. Rather, use of these words is intended to present concepts in a concrete fashion. Moreover, use of the term “an embodiment” or “one embodiment” or “an implementation” or “one implementation” throughout is not intended to mean the same example, embodiment, or implementation unless described as such.

As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. As used herein, the terms “determine” and “identify”, or any variations thereof, includes selecting, ascertaining, computing, looking up, receiving, determining, establishing, obtaining, or otherwise identifying or determining in any manner whatsoever using one or more of the devices shown in FIG. 1.

Further, for simplicity of explanation, although the figures and descriptions herein may include sequences or series of steps or stages, elements of the methods disclosed herein can occur in various orders and/or concurrently. Additionally, elements of the methods disclosed herein may occur with other elements not explicitly presented and described herein. Furthermore, one or more elements of the methods described herein may be omitted, avoided, or excluded from implementations of methods in accordance with the disclosed subject matter.

The implementations of the transmitting computing and communication device 100A and/or the receiving computing and communication device 100B (and the algorithms, methods, instructions, etc. stored thereon and/or executed thereby) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the transmitting computing and communication device 100A and the receiving computing and communication device 100B do not necessarily have to be implemented in the same manner.

Further, in one implementation, for example, the transmitting computing and communication device 100A or the receiving computing and communication device 100B can be implemented using a computer program that, when executed, carries out any of the respective methods, algorithms and/or instructions described herein. In addition, or alternatively, for example, a special purpose computer/processor can be utilized which can contain specialized hardware for carrying out any of the methods, algorithms, or instructions described herein.

The transmitting computing and communication device 100A and receiving computing and communication device 100B can, for example, be implemented on computers in a real-time video system. Alternatively, the transmitting computing and communication device 100A can be implemented on a server and the receiving computing and communication device 100B can be implemented on a device separate from the server, such as a hand-held communications device. In this instance, the transmitting computing and communication device 100A can encode content using an encoder 400 into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting computing and communication device 100A. Other suitable transmitting computing and communication device 100A and receiving computing and communication device 100B implementation schemes are available. For example, the receiving computing and communication device 100B can be a generally stationary personal computer rather than a portable communications device and/or a device including an encoder 400 may also include a decoder 500.

Further, all or a portion of implementations can take the form of a computer program product accessible from, for example, a tangible computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

It will be appreciated that aspects can be implemented in any convenient form. For example, aspects may be implemented by appropriate computer programs which may be carried on appropriate carrier media which may be tangible carrier media (e.g. disks) or intangible carrier media (e.g. communications signals). Aspects may also be implemented using suitable apparatus which may take the form of programmable computers running computer programs arranged to implement the methods and/or techniques disclosed herein. Aspects can be combined such that features described in the context of one aspect may be implemented in another aspect.

The above-described implementations have been described in order to allow easy understanding of the application are not limiting. On the contrary, the application covers various modifications and equivalent arrangements included within the scope of the appended claims, which scope is to be accorded the broadest interpretation so as to encompass all such modifications and equivalent structure as is permitted under the law.

What is claimed is:

1. A method comprising:
obtaining reconstructed block data for a current block of a current frame of a sequence of frames, wherein obtaining the reconstructed block data includes:
obtaining a warp reference list for the current block;
accessing, from an encoded bitstream, a warp reference list index value corresponding to predicted warp motion model parameters from the warp reference list;
obtaining current warp motion model parameters by combining the predicted warp motion model parameters and differential warp motion model parameters determined from the encoded bitstream;
obtaining a motion vector prediction using the current warp motion model parameters;
obtaining predicted block data for the current block using the motion vector prediction;
obtaining decoded block data by decoding encoded block data accessed from the encoded bitstream; and
including, in the reconstructed block data, a sum of the decoded block data and the predicted block data;
including the reconstructed block data in reconstructed frame data for the current frame; and
outputting the reconstructed frame data.

2. The method of claim 1, wherein obtaining the current warp motion model parameters includes:
accessing, from the encoded bitstream, a warp motion model parameters quantization step size mode indicator indicating a warp motion model parameters quantization step size mode;
determining a warp motion model parameters quantization step size in accordance with the warp motion model parameters quantization step size mode;
accessing, from the encoded bitstream, a differential warp motion model parameter index value; and
obtaining a differential warp motion model parameter of the differential warp motion model parameters, wherein obtaining the differential warp motion model parameter includes obtaining the differential warp motion model parameter in accordance with a product of multiplying the differential warp motion model parameter index value by the warp motion model parameters quantization step size.

3. The method of claim 2, wherein determining the warp motion model parameters quantization step size includes:
determining whether the warp motion model parameters quantization step size mode indicator indicates a first warp motion model parameters quantization step size mode.

4. The method of claim 3, wherein determining the warp motion model parameters quantization step size includes:
in response to determining that the warp motion model parameters quantization step size mode indicator indicates the first warp motion model parameters quantization step size mode, identifying, as the warp motion model parameters quantization step size, a result of left shifting one by a first defined value.

5. The method of claim 4, wherein the first defined value is eleven.

6. The method of claim 3, wherein determining the warp motion model parameters quantization step size includes:
in response to determining that the warp motion model parameters quantization step size mode indicator indicates a warp motion model parameters quantization step size mode other than the first warp motion model parameters quantization step size mode, identifying, as the warp motion model parameters quantization step size, a result of left shifting one by a second defined value.

7. The method of claim 6, wherein the second defined value is ten.

8. The method of claim 1, wherein obtaining the current warp motion model parameters includes:
determining a cardinality of the current warp motion model parameters in accordance with the warp reference list index value, wherein:
on a condition that the warp reference list index value has a first value, determining the cardinality of the current warp motion model parameters includes identifying six as the cardinality of the current warp motion model parameters; and
on a condition that the warp reference list index value has a second value, determining the cardinality of the current warp motion model parameters includes identifying four as the cardinality of the current warp motion model parameters.

9. The method of claim 1, wherein obtaining the reconstructed block data includes:
accessing, from the encoded bitstream, a data element indicating that a prediction mode for the current block is a warp motion vector prediction mode.

10. A non-transitory computer-readable storage medium storing an encoded bitstream for decoding by a processor, the encoded bitstream comprising:
a warp reference list index value corresponding to predicted warp motion model parameters from a warp reference list;
a differential warp motion model parameters quantization step size mode indicator indicating a differential warp motion model parameters quantization step size mode for obtaining a differential warp motion model parameters quantization step size;
a differential warp motion model parameter index value; and
encoded block data for a current block of a current frame of a sequence of frames, the encoded block data representing the current block in accordance with a warped motion prediction mode corresponding to current warp motion model parameters obtained in accordance with the predicted warp motion model parameters and differential warp motion model parameters obtained in accordance with the differential warp motion model parameter index value and the differential warp motion model parameters quantization step size.

11. The non-transitory computer-readable storage medium of claim 10, wherein the encoded bitstream includes:
a data element indicating that a prediction mode for the current block is a warp motion vector prediction mode.

12. The non-transitory computer-readable storage medium of claim 10, wherein the differential warp motion model parameters quantization step size mode indicator indicates that the differential warp motion model parameters quantization step size mode indicates identifying, as the differential warp motion model parameters quantization step size, a result of left shifting one by eleven.

13. An apparatus comprising:
a non-transitory computer-readable medium; and
a processor configured to execute instructions stored on the non-transitory computer-readable medium to:
obtain reconstructed block data for a current block of a current frame of a sequence of frames, wherein, to obtain the reconstructed block data the processor executes the instructions to:
obtain a warp reference list for the current block;
access, from an encoded bitstream, a warp reference list index value corresponding to predicted warp motion model parameters from the warp reference list;
obtain current warp motion model parameters, wherein, to obtain the current warp motion model parameters, the processor executes the instructions to combine the predicted warp motion model parameters and differential warp motion model parameters determined from the encoded bitstream;
obtain a motion vector prediction, wherein, to obtain the motion vector prediction, the processor executes the instructions to use the current warp motion model parameters to obtain the motion vector prediction;
obtain predicted block data for the current block, wherein, to obtain the predicted block data, the processor executes the instructions to use the motion vector prediction to obtain the predicted block data;
obtain decoded block data, wherein, to obtain the decoded block data, the processor executes the instructions to decode encoded block data accessed from the encoded bitstream; and
include, in the reconstructed block data, a sum of the decoded block data and the predicted block data;
include the reconstructed block data in reconstructed frame data for the current frame; and
output the reconstructed frame data.

14. The apparatus of claim 13, wherein, to obtain the current warp motion model parameters, the processor executes the instructions to:
access, from the encoded bitstream, a warp motion model parameters quantization step size mode indicator indicating a warp motion model parameters quantization step size mode;
determine a warp motion model parameters quantization step size in accordance with the warp motion model parameters quantization step size mode;
access, from the encoded bitstream, a differential warp motion model parameter index value; and
obtain a differential warp motion model parameter of the differential warp motion model parameters, wherein, to obtain the differential warp motion model parameter, the processor executes the instructions to obtain the differential warp motion model parameter in accordance with a product of a multiplication of the differential warp motion model parameter index value by the warp motion model parameters quantization step size.

15. The apparatus of claim 14, wherein, to determine the warp motion model parameters quantization step size, the processor executes the instructions to:
determine whether the warp motion model parameters quantization step size mode indicator indicates a first warp motion model parameters quantization step size mode.

16. The apparatus of claim 15, wherein, to determine the warp motion model parameters quantization step size, the processor executes the instructions to:
in response to a determination that the warp motion model parameters quantization step size mode indicator indicates the first warp motion model parameters quantization step size mode, identify, as the warp motion model parameters quantization step size, a result of a left shift of one by a first defined value.

17. The apparatus of claim 16, wherein the first defined value is eleven.

18. The apparatus of claim 15, wherein, to determine the warp motion model parameters quantization step size, the processor executes the instructions to:
in response to a determination that that the warp motion model parameters quantization step size mode indicator indicates a warp motion model parameters quantization step size mode other than the first warp motion model parameters quantization step size mode, identify, as the warp motion model parameters quantization step size, a result of a left shift of one by a second defined value.

19. The apparatus of claim 13, wherein, to obtain the current warp motion model parameters, the processor executes the instructions to:
determine a cardinality of the current warp motion model parameters in accordance with the warp reference list index value, wherein:
on a condition that the warp reference list index value has a first value, to determine the cardinality of the current warp motion model parameters, the processor executes the instructions to identify six as the cardinality of the current warp motion model parameters; and
on a condition that the warp reference list index value has a second value, to determine the cardinality of the current warp motion model parameters, the processor executes the instructions to identify four as the cardinality of the current warp motion model parameters.

20. The apparatus of claim 13, wherein, to obtain the reconstructed block data, the processor executes the instructions to:
access, from the encoded bitstream, a data element indicating that a prediction mode for the current block is a warp motion vector prediction mode.
